(19) United States
(12) Patent Application Publication
(10) Pub. No.: US 2026/0368286 A1
(43) Pub. Date: Nov. 19, 2026

(54) SYSTEM AND METHOD FOR DIGITAL CUTOFF GRADE DETERMINATION AND APPLICATION IN BLOCKCHAIN-BASED GOLD DEPOSIT TOKENIZATION

(71) Applicant: NatGold Digital Ltd., Miami, FL (US)

(72) Inventor: Anthony Wade Wile, Carson City, NV (US)

(21) Appl. No.: 19/576,493

(22) Filed: Mar. 24, 2026

Related U.S. Application Data
(60) Provisional application No. 63/777,373, filed on Mar. 25, 2025.
(60) Provisional application No. 63/777,379, filed on Mar. 25, 2025.
(60) Provisional application No. 63/794,662, filed on Apr. 25, 2025.
(60) Provisional application No. 63/794,674, filed on Apr. 25, 2025.

(51) Int. Cl. G06F 21/10; G06Q 20/36; G06Q 50/02

(52) U.S. Cl. CPC G06F 21/1014; G06Q 20/36; G06Q 50/02

(57) ABSTRACT

A method for tokenizing unmined gold deposits comprising receiving proof of title documentation and resource verification documentation compliant with at least one regulatory standard for an unmined gold deposit. The method includes generating a digital cutoff grade for the unmined gold deposit based on a geological confidence factor assigned to a resource classification of the unmined gold deposit. A net present value is calculated based at least in part on the digital cutoff grade, and a total quantity of distributable tokens is determined based on the net present value. A set of distributed ledger tokens representing fractional interests of the net present value is issued, recorded in a distributed ledger maintained across a plurality of validating nodes, and transferred to an electronic wallet associated with a titleholder.

### CROSS-REFERENCE TO RELATED APPLICATIONS

This application claims the benefit of U.S. Provisional Application No. 63/777,373, titled “Real Time Mining Index System Method and Apparatus,” filed on Mar. 25, 2025, U.S. Provisional Application No. 63/777,379, titled “Method and System of Real Time Valuation of Unmined Gold Deposits for Tokenization,” filed on Mar. 25, 2025, U.S. Provisional Application No. 63/794,662, titled “System and Method and Apparatus for Creating a Digital Cutoff Grade,” filed on Apr. 25, 2025, and U.S. Provisional Application No. 63/794,674, titled “System, Method, and Apparatus for Tokenizing Unmined Gold Deposits Using a Digital Cutoff Grade,” filed on Apr. 25, 2025, the entire disclosures of which are hereby incorporated by reference herein.

### BACKGROUND

Traditional methods of representing and trading unmined mineral assets, particularly gold deposits, have faced challenges. The mining industry has struggled with creating reliable digital representations of physical assets that meet rigorous verification standards while maintaining regulatory compliance. Current systems often lack integration between physical resource management and digital trading platforms, making it difficult to track and verify mining activities against digital representations. Additionally, existing solutions have not adequately addressed the growing need for environmental consideration tracking and verification in mining operations.

The industry has also faced persistent challenges in transaction security and access rights management when dealing with representations of unmined assets. Traditional trading systems often lack mechanisms for protecting participants during digital asset exchanges and fail to provide adequate frameworks for managing and verifying mining access rights. Furthermore, the absence of standardized methods for incorporating environmental, social, and governance (ESG) considerations into digital trading platforms has created obstacles for responsible resource management.

Resource classification systems for mineral deposits typically categorize resources based on geological confidence levels. Inferred resources represent the lowest confidence level, based on limited sampling and geological evidence. Indicated resources reflect moderate confidence, supported by adequately spaced sampling and testing. Measured resources represent the highest confidence level, based on detailed and reliable exploration, sampling, and testing. Reserve classifications, which represent economically mineable portions of resources, include probable reserves derived from indicated and sometimes measured resources, and proven reserves derived from measured resources.

Blockchain technology and distributed ledger systems have emerged as potential solutions for creating digital representations of physical assets. These systems utilize cryptographic linking between sequential data blocks to help ensure data integrity and immutability. Smart contracts, which are self-executing contracts written into code on the blockchain, can encode various terms and conditions related to asset ownership and transfer. However, the application of these technologies to unmined mineral assets presents various technical and regulatory considerations that have not been fully addressed by existing approaches.

Traditional cutoff grade methodologies for gold deposits were designed with physical mining economics as their primary focus, evaluating deposits based on immediate extraction feasibility, operating costs, and market prices to determine economic viability. However, this framework is fundamentally misaligned with the requirements of digital tokenization of unmined gold resources. These approaches evaluate deposits based on immediate extraction feasibility, operating costs, and market prices to determine economic viability. However, this framework is fundamentally misaligned with the requirements of digital tokenization of unmined gold resources.

For example, economic extraction emphasis creates a fundamental disconnect with digital token requirements. Conventional cutoff grades prioritize short-term economic extraction parameters rather than the long-term reliability of the resource as a stable backing asset. Digital tokens require a valuation model that emphasizes the credibility and accessibility of the gold over immediate mining economics.

Furthermore, the integration of risk factors is severely limited in traditional methodologies. In this regard, conventional methodologies inadequately account for the multifaceted risk landscape affecting unmined resources, including geological uncertainty, physical accessibility challenges, geopolitical instability, and ESG constraints. This oversight results in overvaluation of deposits that may face significant non-economic barriers to utilization.

A critical temporal mismatch exists between mining economics and token timeframes. Standard mining cutoff grades focus on near-term extraction possibilities, whereas digital tokens representing unmined gold may incorporate much longer time horizons for potential redemption or monetization. This discrepancy undermines the reliability of conventional metrics for token backing.

Investor confidence demands more sophisticated valuation frameworks than mining cutoff grades can provide. Digital currency markets require transparent, systematic approaches to underlying asset valuation that traditional mining metrics don't deliver, potentially undermining investor confidence in token stability and long-term value.

### BRIEF SUMMARY

Aspects of the present application are directed to a system configured to implement processes relating to providing a secure, legally compliant, and environmentally conscious system for representing and trading unmined gold deposits in a digital realm (herein referred to as an “asset management system”). According to embodiments, the asset management system provides secure, verified digital representation of unmined gold deposits while maintaining regulatory compliance and environmental consciousness. Advantageously, the asset management system addresses challenges in the digitization and trading of unmined gold deposits by implementing verification standards (e.g., NI 43-101, S-K 1300) in representing physical gold deposits in digital form to ensure that resource estimates are properly authenticated by qualified persons, and integrating a digital cutoff grade methodology that provides a risk-adjusted framework for accurate valuation of unmined gold as digital currency backing. As used herein, the term “digital cutoff grade” refers to the minimum ore grade required for a gold deposit to qualify as credible backing for a digital currency, adjusted for various risk factors. According to embodiments, the digital cutoff grade is generated by establishing a target gold content representing the desired effective gold content to provide backing for digital tokens, and dividing the target gold content by one or more geological confidence factors assigned to a corresponding resource classification (e.g., a geological confidence factor of 0.8 is assigned to measured resources, a geological confidence factor of 0.4 is assigned to indicated resources, and a geological confidence factor of 0.2 is assigned to inferred resources, as described in greater detail below).

According to embodiments, the digital cutoff grade is used in the valuation process to calculate a net present value for the deposit by applying resource classification multipliers corresponding to the geological confidence factors. According to embodiments, a total quantity of distributable tokens is determined by dividing the calculated net present value by a standardized unit value derived from market comparable transactions for similar deposits. According to embodiments, distributed ledger tokens representing fractional interests in the validated deposit value are issued, with each token incorporating a smart contract that includes references to the underlying resource calculations and technical assumptions, establishes mechanisms for value updates based on new technical data or market conditions, and defines token holder rights regarding value realization.

According to embodiments, the digital cutoff grade may be modified by applying additional risk factors including accessibility considerations, geopolitical stability analysis, and Environmental, Social, and Governance (ESG) criteria to generate a composite credibility factor. According to embodiments, a hybrid risk-adjusted digital cutoff grade may be determined by dividing the target gold content by the composite credibility factor, providing a more nuanced valuation framework that acknowledges that even geologically certain deposits may face significant barriers to realization.

According to embodiments, the asset management system may integrate ESG crediting systems with the smart contract infrastructure, tracking key metrics against permitted thresholds. According to embodiments, the ESG crediting systems may incorporate the environmental and ESG factor from the hybrid risk-adjusted digital cutoff grade methodology, allowing for quantification of environmental, social, and governance risks. According to embodiments, the environmental and ESG factor may be calculated using environmental restriction databases, social opposition incident records, indigenous rights frameworks, and governance compliance assessments, providing a numerical value between 0 and 1 that represents ESG-related feasibility for use in the composite credibility factor calculation.

Advantageously, the asset management system implements a digital cutoff grade (DCG) methodology that incorporates a risk-adjusted framework that more accurately reflects the reliability and credibility of unmined gold as a digital currency backing. By transitioning from cost-focused evaluations to holistic resource credibility assessments, the DCG methodology employed by the asset management system provides a more appropriate and accurate basis for tokenizing gold assets that may remain unmined for extended periods of time.

The foregoing general description of the illustrative embodiments and the following detailed description thereof are merely exemplary aspects of the teachings of this disclosure and are not restrictive.

### General Terms

“digital cutoff grade (DCG)”: The minimum ore grade, expressed in grams per ton (g/t), required for a gold deposit to qualify as credible backing for a digital currency, adjusted for various risk factors.
“traditional cutoff grade”: The minimum grade at which a mineral resource can be economically mined, considering operating costs, processing costs, and metal prices.
“resource classification”: A standardized system categorizing mineral resources by geological certainty levels (Measured, Indicated, Inferred).
“target gold content (G_target)”: The desired effective gold content per ton (g/t) necessary to provide adequate backing for a digital currency based on acceptable risk-adjusted standards.
“pure digital cutoff grade”: A DCG approach focused exclusively on geological certainty.
“hybrid risk-adjusted digital cutoff grade”: A DCG approach that incorporates multiple risk dimensions beyond geological confidence.
“geological confidence factor”: A numerical representation of resource certainty, with standard classifications as follows: Measured=0.8, Indicated=0.4, Inferred=0.2.
“composite credibility factor”: The product of all applicable risk factors (geological, accessibility, geopolitical, and ESG), representing the overall reliability of a resource for tokenization purposes.

### Traditional Cutoff Grade Factors

“operating costs”: Direct costs associated with mining activities including labor, equipment, maintenance, and consumables.
“processing costs”: Expenses related to ore treatment, including crushing, grinding, and chemical processing to extract valuable minerals.
“metal price”: Market value of gold used in economic calculations to determine feasibility.
“recovery rate”: Percentage of gold that can be extracted from the ore during processing.
“dilution”: The mixing of waste material with ore during mining operations, reducing the overall grade.
“mining method”: The technique used to extract ore (open pit, underground), which significantly affects costs and cutoff grade calculations.

### Pure Digital Cutoff Grade Factors

“measured resources”: Highest confidence mineral resources where quantity, grade, and physical characteristics are estimated with sufficient confidence to support detailed mine planning.
“indicated resources”: Mineral resources with moderate confidence level, where quantity, grade, and physical characteristics are estimated with sufficient confidence for preliminary economic assessments.
“inferred resources”: Lowest confidence mineral resources, where quantity and grade are estimated with limited geological evidence and sampling.

### Hybrid Risk-Adjusted Digital Cutoff Grade Factors

“accessibility factor (F_access)”: A quantifier of logistical and technological feasibility, where 1.0 indicates full accessibility and values below reflect increasing difficulty due to geographical remoteness, depth, or technological limitations.
“geopolitical stability factor (F_pol)”: A factor representing political and regulatory reliability, where 1.0 signifies high stability and lower values indicate heightened risks of resource confiscation, expropriation, or legal impediments.
“environmental and ESG factor (F_ESG)”: A coefficient reflecting the likelihood of environmental or social opposition, where values approaching 1.0 denote minimal risk and lower values indicate significant barriers to resource utilization.
“depth considerations”: Assessment of mining challenges associated with deposit depth, affecting accessibility and extraction costs.
“infrastructure presence”: Evaluation of existing transportation, energy, and water infrastructure that impacts resource accessibility.
“resource nationalism”: Political risk of a host country increasing state control over natural resources through increased taxation, royalties, or outright expropriation.
“jurisdictional control”: Legal framework and governance affecting mining rights and operations within a specific jurisdiction.

### Conversion Methodology Terms

“composite credibility factor”: The product of all applicable risk factors (geological, accessibility, geopolitical, and ESG), representing the overall reliability of a resource for tokenization purposes.
“economic extraction nullification”: The process of removing economic considerations from traditional cutoff grades by setting them to zero for digital tokenization purposes.
“temporal accessibility”: Consideration of potential mining realization timelines, particularly relevant if the digital currency model allows future physical redemption or monetization of the in-ground resource.
“token backing ratio”: The relationship between digital tokens issued and the amount of gold resource they represent, potentially adjusted by the Digital Cutoff Grade.
“risk-adjusted resource”: The effective resource size after application of all relevant risk factors through the Digital Cutoff Grade methodology.
“tokenization framework”: The overall system for converting physical gold resources into digital representations, including technical, legal, and valuation components.

### Blockchain and Related Terms

“artifact” means a self-contained piece of digital content that can be referenced and updated throughout a blockchain system.
“blockchain” refers to a distributed, immutable ledger that records transactions across a network of computers.
“consensus mechanism” refers to the protocol by which the network reaches agreement on the valid state of the blockchain.
“deep web network address” means a network location that cannot be indexed by web search engines.
“distributed ledger” means a consensus of replicated, shared, and synchronized digital data.
“hash” means a function that converts an input of data into a fixed-size string of text.
“mining” means validating and adding new transactions to the blockchain through computation.
“network interface” means a software or hardware interface between network sections.
“node” refers to a computer or device that participates in the blockchain network.
“permissioned blockchain” means a blockchain where only selected participants can validate.
“private key” means a secret number that allows cryptocurrency transactions to be signed.
“public key” refers to a cryptographic code that allows users to receive cryptocurrency transactions.
“smart contract” means self-executing contracts written into code on the blockchain.
“token” means a digital asset created and managed on the blockchain.
“transaction wallet” means a temporary digital wallet created for a specific transaction.
“user wallet address” means an alphanumeric code for receiving and transmitting transactions.
“wallet” refers to software that allows users to store and manage their private keys.

### Gold Deposit and Resource Terms

“assay” refers to testing of metal or ore to determine ingredients and quality.
“core sample” means a cylindrical section of rock obtained by drilling.
“cut-off grade” means the minimum grade of economically mineable mineralization.
“grade” means the concentration of gold within the ore.
“geophysical survey” means using physical methods to measure rock properties.
“metallurgical recovery” means the percentage of gold extractable from ore.
“NI 43-101” refers to Canadian standards for reporting mineral properties.
“physical mining” means extraction and processing of mineral resources.
“probable reserves” means the economically mineable part of an Indicated Resource
“proven reserves” means the economically mineable part of a Measured Resource
“qualified person” means a professional credentialed to validate resource estimates.
“resource classification” means systematic categorization of mineral resources.
“resource estimate” means professional assessment of deposit quantity and grade.
“resource verification documentation” means official validation of mineral resources.
“S-K 1300” means the SEC's mining property disclosure requirements.
“strike length” means the longest horizontal dimension of an ore body.
“unmined gold deposit” means a natural concentration of gold-bearing material.

### Environmental, Social, and Governance (ESG) Terms

### Environmental Terms

“biodiversity impact” means the effect on local flora and fauna.
“carbon footprint” means total greenhouse gas emissions from mining activities.
“environmental baseline” means initial environmental conditions.
“environmental preservation requirements” means obligations to maintain environments.
“environmental risk assessment” means evaluation of potential impacts.
“preservation value” means ecological worth of maintaining natural state.
“water management” means strategies for protecting water resources.

### Social Terms

“community development agreement” means formal agreements with local communities.
“community impact” means effect on local communities and indigenous peoples.
“cultural heritage” means archaeological, historical, or cultural significance.
“indigenous rights” means rights of indigenous peoples regarding land.
“social license” means level of acceptance by local communities.
“stakeholder engagement” means process of involving relevant parties.

### Governance Terms

“Environmental, Social, and Governance (ESG) compliance” means adherence to environmental, social, and governance standards.
“ESG crediting system” means system for tracking ESG compliance.
“ESG reporting standards” means frameworks for ESG disclosure.
“regulatory oversight” means governance structure ensuring compliance.
“resource verification systems” means technologies for validating resources.
“stakeholder rights” means established rights of interested parties.
“Sustainable Development Goals” means the UN's global goals.
“Transparency Framework” means system for reporting ESG information.

### Digital ESG Integration Terms

“digital signature authorization” means cryptographic validation of rights transfer.
“ESG smart contract” means blockchain contracts encoding ESG requirements.
“ESG token attributes” means ESG characteristics embedded in tokens.
“impact verification oracle” means third-party ESG compliance data sources.
“real-time operational monitoring” means continuous tracking of metrics.
“sustainability metrics” means quantifiable ESG indicators.
“token burning protocol” means process for removing tokens from circulation.

### BRIEF DESCRIPTION OF THE FIGURES

To easily identify the discussion of any particular element or act, the most significant digit or digits in a reference number refer to the figure number in which that element is first introduced.

FIG. 1A is an example network diagram showing technical infrastructure of a networked computing environment including an asset management system for tokenizing unmined gold deposits by generating a digital cutoff grade that establishes resource credibility based on geological confidence factors, and using the digital cutoff grade in a valuation process to issue distributed ledger tokens representing fractional interests in the validated deposit value, according to one or more embodiments.

FIG. 1B illustrates a comparison of multiple digital cutoff grade generation processes implemented by an asset management system, according to one or more embodiments.

FIG. 2 is a block diagram illustrating an example resource classification mapping framework implemented by an asset management system, according to one or more embodiments.

FIG. 3 is a block diagram illustrating an example hybrid risk-adjusted digital cutoff grade generation process executed by an asset management system, according to one or more embodiments.

FIG. 4 is a block diagram illustrating example digital cutoff grade calculation processes executed by an asset management system, including transformational algorithms and computational workflows forming the calculation engines, according to one or more embodiments.

FIG. 5 is a block diagram illustrating a traditional-to-digital cutoff grade conversion process executed by an asset management system, showing economic parameter extraction, nullification calculation, risk factor incorporation, and audit documentation generation, according to one or more embodiments.

FIG. 6 is a flow diagram illustrating an example pure digital cutoff grade generation process executable by an asset management system, according to one or more embodiments.

FIG. 7 is a block diagram illustrating an example hardware and data flow architecture implemented by an asset management system for digital cutoff grade calculations within a tokenization environment, according to one or more embodiments.

FIG. 8 is a block diagram illustrating an example tokenization output process executable by an asset management system, according to one or more embodiments.

FIG. 9 is a flow chart illustrating an example process for determining and tokenizing a value of verified unmined gold deposits, according to one or more embodiments.

FIG. 10 is a flow chart illustrating an example process for tokenizing verified unmined gold deposits using a digital cutoff grade to calculate a net present value for the deposit, according to one or more embodiments.

FIG. 11 is a flow chart showing an example process for secure transfer of blockchain tokens representing interests in unmined gold deposits, including steps for displaying deposit information, receiving exchange orders, and processing token transfers, according to one or more embodiments.

FIG. 12 is a flow chart depicting an example process for calculating and displaying token quantities corresponding to cryptographic currency values based on exchange rates for unmined gold deposit tokens, according to one or more embodiments.

FIG. 13 is a flow chart illustrating an example process for converting specified quantities of blockchain tokens representing unmined gold deposits into corresponding cryptographic currency values using current exchange rates, according to one or more embodiments.

FIG. 14 is a flow chart showing an example process for executing secure exchanges between cryptographic currency and blockchain tokens representing unmined gold deposits through deep web transaction mechanisms, according to one or more embodiments.

FIG. 15 is a flow chart depicting an example process for obtaining and managing access rights to unmined gold deposits through token-based smart contracts, including steps for identity verification and environmental compliance, according to one or more embodiments.

FIG. 16 is an architectural diagram illustrating an example distributed electronic ledger system incorporating multiple validation nodes and consensus mechanisms for maintaining the integrity of unmined gold deposit token transactions, according to one or more embodiments.

FIG. 17 is a diagram illustrating example components and architecture of a computing system implementing the tokenization and trading functionality, including processors, memory systems, and input/output (I/O) components, according to one or more embodiments.

### DETAILED DESCRIPTION

The disclosed technology encompasses blockchain systems, distributed ledger methodologies, and/or computer program commodities at varying degrees of technical integration (herein referred to as an “asset management system”). Such a computer program commodity may comprise a machine-readable storage medium (or multiple mediums) bearing machine-executable instructions to prompt a processor to execute components of the specified blockchain technology, including smart contracts, token creation, and distributed consensus mechanisms.

Aspects of the present disclosure are related to a computer-implemented system (the asset management system) for tokenizing verified assets (e.g., unmined gold deposits) by transforming physical asset documentation into standardized blockchain-based digital tokens. According to embodiments, the asset management system employs machine learning models and automated processing algorithms to validate proof of title, verify resource documentation compliant with regulatory standards (e.g., NI 43-101 and/or S-K 1300), and calculate distributable token quantities based on geological data and risk assessment factors. Through smart contract generation and distributed ledger technology, the asset management system creates fungible digital tokens that represent fractional interests in verified gold deposits, with each token incorporating standardized unit values and embedded contractual terms for secure transfer and ownership management. The asset management system addresses technical challenges in digital asset representation by providing automated, scalable processes that ensure regulatory compliance, maintain data integrity through cryptographic validation, and enable secure trading of unmined mineral asset rights in a digital environment.

According to embodiments, the asset management system includes real-time digital cutoff grade calculation systems, distributed tokenization methodologies, and computer program commodities at varying degrees of technical integration. Such a computer program commodity may comprise a machine-readable storage medium (or multiple mediums) bearing machine-executable instructions to prompt a processor to execute components of the specified digital cutoff grade technology, including resource data acquisition, risk factor computation, and dynamic token valuation mechanisms.

According to embodiments, the asset management system includes one or more specialized data ingestion modules configured to process diverse national formats of resources (e.g., gold ore resource reports, including but not limited to JORC (Australia), NI 43-101 (Canada), SAMREC (South Africa), PERC (Europe), SME (United States), and CIM (Canada)). According to embodiments, the data ingestion modules may employ natural language processing and structured data extraction algorithms to normalize heterogeneous resource classification systems, terminology variations, and reporting standards into a unified data schema.

According to embodiments, the asset management system performs a standardization process that includes automated extraction of resource tonnage, grade, and classification data from various report formats. The asset management system maps country-specific resource classification terminology to standardized Measured, Indicated, and Inferred categories, and converts between different units of measurement such as metric tons, short tons, troy ounces, and grams. The asset management system reconciles different reporting cut-off grades used in original resource statements and identifies and normalizes confidence factors applied in different national reporting codes. Additionally, the asset management system extracts geospatial data, depth information, and geological context descriptions, and recognizes and processes ESG-related disclosures in different reporting formats.

According to embodiments, the asset management system employs adaptive machine learning algorithms that continuously perform report parsing to improve accuracy through supervised learning techniques, while reducing manual intervention requirements over time. According to embodiments, the asset management system maintains an audit trail of all transformations applied to original report data to ensure transparency and data provenance.

According to embodiments, the asset management system is configured to implement multiple different digital cutoff grade generation processes for tokenization valuation. According to embodiments, the asset management system implements a pure digital cutoff grade process that focuses exclusively on geological certainty, creating a streamlined metric that considers only the confidence in the existence and quantity of gold resources. The asset management system evaluates gold deposits solely on their classification (e.g., a measured resource classification, an indicated resource classification, or an inferred resource classification), with corresponding reliability factors applied directly to the target gold content. In an embodiment, the asset management system applies the following example formula to generate the DCG using the pure digital cutoff grade approach (DCG_pure):

DCG_pure=G_target/F_geo;

where “G_target” represents target gold content (e.g., a desired effective gold content per ton (g/t) necessary to provide adequate backing for a digital currency based on acceptable risk-adjusted standards) and “F_geo” represents a geological confidence factor.

According to embodiments, the asset management system is configured to implement a hybrid risk-adjusted digital cutoff grade process that expands beyond geological factors to incorporate a risk assessment framework. In this embodiment, the asset management system evaluates gold resources through multiple dimensions, where geological confidence is supplemented with accessibility considerations, geopolitical stability analysis, and Environmental, Social, and Governance (ESG) criteria. The asset management system assigns each dimension a quantifiable factor between zero and one, creating a multiplicative model that produces a composite risk profile using, for example, the following formula to generate the hybrid risk-adjusted digital cutoff grade (DCG_hybrid):

DCG_hybrid=G_target/(F_geo×F_access×F_pol×F_ESG);

where “F_access” (accessibility factor) represents a quantifier of logistical and technological feasibility, where, for example, 1.0 indicates full accessibility and values below reflect increasing difficulty due to geographical remoteness, depth, or technological limitations; “F_pol” (geopolitical stability factor) is a factor representing political and regulatory reliability, where, for example, 1.0 signifies high stability and lower values indicate heightened risks of resource confiscation, expropriation, or legal impediments; and “F_ESG” (Environmental and ESG Factor) is a coefficient reflecting the likelihood of environmental or social opposition, where, for example, values approaching 1.0 denote minimal risk and lower values indicate significant barriers to resource utilization.

According to embodiments, the asset management system implements a conversion process that bridges traditional mining economics and digital asset valuation. In this embodiment, the asset management system begins with established cutoff grades for mining operations and systematically transforms them for tokenization purposes. According to embodiments, the asset management system initially nullifies economic extraction considerations and then applies one or more geological, accessibility, geopolitical, and ESG factors according to standardized criteria.

According to embodiments, the asset management system implements a token architecture through a series of smart contracts deployed on an enterprise-grade blockchain platform. The asset management system encodes the digital cutoff grade calculations within these smart contracts, applying appropriate formulas to determine the minimum ore grade required for gold deposits to qualify as credible backing for digital tokens.

For example, for the pure digital cutoff grade process, the smart contracts are encoded to calculate the pure digital cutoff grade (DCG_pure) according to the following example expression:

DCG_pure=G_target/F_geo.

where G_target is the Target Gold Content and F\_geo is the Geological Confidence Factor. For The asset management system encodes the relationship between physical claims and digital tokens within these contracts, incorporating resource documentation through smart contracts that reference authenticated NI 43-101 or S-K 1300 technical reports and storing claim coordinates and resource estimates on-chain.

In an embodiment, for the hybrid risk-adjusted process, the smart contracts are encoded to calculates the hybrid DCG according to the following example expression:

DCG_hybrid=G_target/F_composite

where F_composite=F_geo×F_access×F_pol×F_ESG.

According to embodiments, the asset management system provides a structured methodology for amending traditional technical reports into amended documentation suitable for digital tokenization. According to embodiments, the asset management system performs resource classification mapping by standardizing multiple different types of national reporting formats (e.g., JORC, NI 43-101, SAMREC, PERC, SME, GKZ, CMREC, etc.) into unified classifications through a mapping engine that identifies semantic equivalences between classification terms and evaluates underlying technical criteria.

According to embodiments, the asset management system performs risk factor quantification for Hybrid Risk-Adjusted implementations by transforming qualitative risk assessments into numerical factors through transformational analytical processes that evaluate accessibility challenges, geopolitical risks, and ESG concerns and represents them as weighted factors.

According to embodiments, the asset management system performs digital cutoff grade calculation by replacing traditional economic cutoff grades in the amended technical report with calculated Digital Cutoff Grades using the appropriate methodology based on tokenization objectives. The asset management system generates revised resource tables showing both traditional economic cutoff grade values and DCG-adjusted values.

According to embodiments, the asset management system performs validation and transparency functions wherein the amended technical report undergoes validation by qualified persons and maintains a complete audit trail of all transformations applied to the original report data, ensuring transparency and data provenance for tokenization purposes.

According to embodiments, the asset management system includes machine-readable medium which is a physical entity capable of maintaining and storing instructions to be utilized by an instruction execution apparatus, including blockchain nodes, mining equipment, and validation systems. The medium could be, for example, but not restricted to, electronic, magnetic, optical, electromagnetic, semiconductor storage devices, or a fusion of these. A non-limiting list of specific instances of the machine-readable medium includes portable computer diskettes, hard drives, RAM, ROM, EPROM or Flash memory, SRAM, CD-ROMs, DVDs, memory sticks, floppy disks, and mechanical devices like punch-cards or tangible structures with instructions. It should be clarified that the aforementioned medium does not consider transitory signals in isolation, like free-propagating electromagnetic waves or electrical signals over wires.

The machine-executable instructions detailed can be transferred to diverse computational devices, including blockchain nodes and mining systems, from the machine-readable medium or an external computer or storage via networks like the Internet, LANs, WANs, or wireless networks. Such networks may integrate copper or optical fibers, wireless transmission mechanisms, routers, firewalls, switches, gateway computers, and edge servers. Within each computational device, a network interface or adapter fetches the instructions from the network, forwarding them for retention in the device's machine-readable medium and blockchain ledger.

Instructions facilitating blockchain operations of this technology might be encoded as smart contracts, consensus algorithms, mining protocols, or code (both source and object) in diverse programming languages. Examples include but aren't restricted to blockchain-specific languages like Solidity, as well as object-oriented languages like Python, Java, C++, and procedural ones like the “C” language. These instructions might operate wholly on a local blockchain node, partly on local and remote nodes, or entirely across the distributed network. Remote nodes can be linked via peer-to-peer networks, inclusive of the Internet via ISPs. In certain cases, specialized processing hardware such as resource modeling systems or real-time tokenization engines could employ the instructions, utilizing their state data to actualize facets of the digital cutoff grade generation and implementation technology.

Aspects of the present disclosure are described herein with reference to flowcharts and block diagrams of methods, systems, and computer program products per its various DCG calculation methodologies. Each block in these can be realized via machine-executable instructions, including smart contracts and consensus mechanisms, executable by an asset management system, according to embodiments of the present disclosure.

According to embodiments, the instructions may be presented to a processor in general-purpose computers, specialized mining computers, or other programmable data apparatuses of the asset management system, to enable execution of the functions and operations denoted in the diagrams. Furthermore, according to embodiments, the instructions may be conserved, maintained, or stored within a distributed ledger directing nodes to operate in a specific fashion. According to embodiments, the instructions could also be loaded onto a blockchain node or mining device to prompt a sequence of tasks producing a blockchain-driven process.

The depicted flowcharts and diagrams exhibit example embodiments of asset tokenization management, related processes or methods, and product architectures and functionalities per the technology's blockchain solution variants. According to embodiments, the processes of the asset management system, may be implemented by specialized blockchain systems designed for those tasks or combinations of hardware and machine instructions.

For the purposes of this application when referencing NI 43-101 (Canadian) and S-K 1300 (US) standards, these are National regulatory standards for reporting mineral resources and reserves.

According to embodiments, the asset management system implements processes including features and operations relating to resource classification including inferred resource classification (e.g., lowest confidence level, based on limited sampling and geological evidence), indicated resource classification (e.g., moderate confidence, supported by adequately spaced sampling and testing), and measured resource classification (e.g., highest confidence, based on detailed and reliable exploration, sampling, and testing.

According to embodiments, the asset management system implements processes including features and operations relating to reserve classification (e.g., associated with economically mineable deposits) including probable reserves (e.g., reserves derived from indicated and/or measured resources) and proven reserves (e.g., derived from measured resources only).

According to embodiments, the asset management system is configured to implement one or more valuation methods to generate valuations for resources and reserves which integrates multiple components or factors to determine the economic value of mineral deposits. According to embodiments, resource confidence levels serve as the basis for valuation, with each resource classification type or level receiving a specific risk-adjusted multiplier to reflect one or more aspects or parameters, such as, for example, geological certainty.

According to embodiments, the valuation may include one or more technical factors. In an embodiment, the technical factors may include or consider one or more of metallurgical recovery rates based on test work, mining dilution derived from geotechnical studies, and processing costs determined through engineering studies. In an embodiment, the valuation may include considerations such as national jurisdictional and treaty considerations to evaluate royalty structures, taxation regimes, and timeline impacts on project economics. In some variants of the solution, market comparable analysis examines similar deposits in terms of grade, tonnage, and jurisdiction to validate valuations against estimated data.

According to embodiments, the valuation calculation method may include verification of base resource and reserve tonnages and grades through qualified person review. In an embodiment, the valuation calculation method may include the consideration of technical modifying factors that are applied to account for one or more factors such as mining recovery, dilution, processing performance, etc. According to embodiments, the valuation calculation method may include an estimation of operating and capital costs, incorporating one or more capital-related costs relating to equipment, labor, consumables, infrastructure requirements, etc.

According to embodiments, the valuation calculation method may include the use of revenue projections developed using commodity price forecasts that consider market cyclicality and trends. In an embodiment, risk-adjusted net present value calculations may incorporate discount rates reflecting project stage and jurisdiction. According to embodiment, the process may incorporate a comparable transaction analysis to validate the calculated valuations against market precedents.

According to embodiments, the valuation calculation method may include the use of technical reports and resource estimates that are updated to reflect new drilling, sampling, and geological interpretation. According to embodiments, the valuation calculation method may include commodity price forecasts that are revised based on market conditions and industry consensus. According to embodiments, the valuation calculation method may include market transactions that are analyzed to validate valuation parameters. According to embodiments, the valuation calculation method may include operating cost assumptions that are adjusted for inflation, technological changes, and efficiency improvements. According to embodiments, the valuation calculation method may include the consideration of jurisdictional factors that may be reassessed as regulatory and fiscal regimes change, update, and/or evolve. According to embodiments, the valuation calculation method may include updates that are validated by one or more qualified persons before being reflected in token smart contracts through, for example, oracle-based price feeds.

According to embodiments, the asset management system achieves real-time operational monitoring through integration with token mining operations software via secure API connections.

### ESG Credits and Compliance

According to embodiments, the asset management system can be employed to process ESG credits and compliance via an integration with one or more ESG crediting systems with the smart contract infrastructure to track metrics (e.g., environmental metrics, social metrics, governance metrics) against permitted thresholds. According to embodiments, the asset management system implements ESG crediting systems that are integrated with the smart contract infrastructure, tracking key metrics against permitted thresholds. According to embodiments, the asset management system incorporates the environmental and ESG factor (F\_ESG) from the hybrid variant of the digital cutoff grade methodology, allowing for quantification of environmental, social, and governance risks. According to embodiments, the environmental and ESG factor is calculated using environmental restriction databases, social opposition incident records, indigenous rights frameworks, and governance compliance assessments, providing a numerical value between 0 and 1 that represents ESG-related feasibility. According to embodiments, the asset management system performs digital cutoff grade-ESG correlation analysis that provides quantitative insights into how ESG practices correlate with resource credibility assessments over time, creating a valuation incentive mechanism that reinforces responsible mining practices. The asset management system maintains a continuously updated database of these correlations, enabling it to identify and appropriately value tokenized deposits that demonstrate credibility advantages attributable to sustainable operational practices.

### Digital Cutoff Grade Methodology

According to embodiments, once the resource and reserves estimates are complete, the asset management system calculates the tokenization valuation. According to embodiments, the asset management system implements a digital cutoff grade (DCG) methodology that transitions from cost-focused evaluations to holistic resource credibility assessments.

According to embodiments, the asset management system calculates a pure digital cutoff grade using the following example formula:

DCG_pure=G_target/F_geo;

where G_target is the target gold content and F_geo is the geological confidence factor assigned to each resource classification. According to embodiments, for a more blended evaluation, the asset management system can employ a hybrid risk-adjusted digital cutoff grade that incorporates additional risk factors through the following example formula:

DCG_hybrid=G_target/F_composite;

where F_composite=F_geo×F_access×F_pol×F_ESG.

According to embodiments, this provides a more nuanced valuation framework that acknowledges that even geologically certain deposits may face significant barriers to realization. According to embodiments, exchange ratios are used to convert certified gold into tokens valued at ratios of measured, indicated and inferred resources. According to embodiments, these valuation ratios align with the geological confidence factors (e.g., 0.8 for measured, 0.4 for indicated, and 0.2 for inferred resources) in the digital cutoff grade methodology. According to embodiments, for example, 1.0 oz of measured gold reserves may constitute 0.8 of a token, 1.0 oz of indicated gold reserves may equal 0.4 token, and 1.0 oz of inferred gold reserves may equal 0.2 tokens.

According to embodiments, for digital tokenization purposes, traditional technical reports compliant with NI 43-101 or S-K 1300 standards require adaptation to properly reflect the valuation requirements of digital tokens backed by unmined gold. According to embodiments, the digital cutoff grade (DCG) methodology provides a framework for transforming these technical reports into tokenization-ready documentation.

According to embodiments, the adaptation process begins with a conversion methodology that bridges traditional mining economics and digital asset valuation. According to embodiments, the asset management system starts with conventional cutoff grades established in the original technical report and systematically transforms them for tokenization purposes. According to embodiments, the process first nullifies economic extraction considerations by resetting the traditional cutoff grade to zero, acknowledging that immediate physical mining is not a prerequisite for token backing. According to embodiments, the pure PCG is calculated to address the verified existence of gold without any economic considerations.

According to embodiments, the asset management system also allows for a further adaptation of the DCG, which applies geological, accessibility, geopolitical, and ESG factors according to standardized criteria, calculating a composite credibility factor that reflects overall resource reliability. According to embodiments, the target gold content is adjusted based on this composite factor to determine the final digital cutoff grade. According to embodiments, this conversion allows established mining operations to leverage existing resource models while adapting them to the different requirements of digital asset backing.

According to embodiments, the technical report adaptation includes restatement of resource tonnage and grade tables to reflect DCG-adjusted values rather than traditional economic cutoff grade values. According to embodiments, the adapted report includes detailed explanation of the risk factors considered, their quantification methodologies, and the resulting composite credibility factors applied to each resource classification.

According to embodiments, the amended technical report comprises a new report section explaining the considerations relevant to digital tokenization. According to embodiments, while traditional technical reports focus on near-term extraction economics, DCG-adapted reports address the longer time horizons associated with digital tokens. According to embodiments, this includes an analysis of how resource credibility may evolve over time and the mechanisms for value updates as updated or new information becomes available.

According to embodiments, the adaptation also comprises an expanded disclosure of uncertainty quantification methods. According to embodiments, where traditional technical reports typically focus on geological uncertainty, DCG-adapted reports disclose the risks that could affect token value, including accessibility challenges, geopolitical instability, and ESG constraints.

According to embodiments, the token architecture may be implemented by the asset management system through a series of smart contracts deployed on an enterprise-grade blockchain platform. According to embodiments, these contracts encode the relationship between physical claims and digital tokens, incorporating resource documentation further comprising the use of smart contracts that reference authenticated NI 43-101 or S-K 1300 technical reports, storing claim coordinates and resource estimates on-chain. According to embodiments, claim coordinates and resource estimates are stored on-chain, and are updatable only by authorized Qualified Persons through protocols that confirm their authenticity. According to embodiments, these resources are updatable by authorized qualified persons through protocols that confirm the authenticity of the qualified persons. According to embodiments, implementation of on-chain KYC/AML verification may be managed through integration with established compliance providers.

According to embodiments, the asset management system can be configured to employ a tokenized warehouse receipt form or format which represents a standardized digital format of a traditional warehouse receipt, adapted specifically for unmined gold deposits. Similar to how agricultural commodities use warehouse receipts under USDA frameworks, tokenized warehouse receipts for unmined gold deposits provide a legally recognized structure for representing ownership rights of verified underground resources while maintaining physical preservation of the deposit.

Advantageously, the use of digital receipts operate under established legal frameworks, particularly Uniform Commercial Code (UCC) Article 7, which governs documents of title including warehouse receipts. According to embodiments, the adaptation of this traditional structure to blockchain technology maintains the legal certainty of warehouse receipts while adding the benefits of digital transfer and tracking. A tokenized warehouse receipt directly represents a specific quantity of verified gold resources through a standardized format compliant with state warehouse receipt requirements, establishing clear chain of title and ownership rights while integrating with existing commodity trading frameworks. According to embodiments, this structure effectively separates the receipt from corporate entity ownership while maintaining compliance with state-level commodity warehouse regulations.

According to embodiments, this warehouse receipt framework provides the foundation for subsequent blockchain implementation and distributed ledger systems, ensuring that the technical architecture serves and enhances established legal structures rather than attempting to replace them. According to embodiments, the asset management system provides for the integration of traditional warehouse receipt concepts with modern blockchain technology to create a methodology for representing and trading unmined gold deposit rights while maintaining regulatory compliance and market accessibility.

According to embodiments, the asset management system implements real-time operational monitoring through integration with token mining operations software via one or more secure API connections.

According to embodiments, the asset management system is configured to process ESG credits and compliance via an integration with one or more ESG crediting systems with the smart contract infrastructure to track metrics (e.g., environmental metrics, social metrics, governance metrics) against permitted thresholds. According to embodiments, the asset management system implements ESG crediting systems that are integrated with the smart contract infrastructure, tracking key metrics against permitted thresholds. According to embodiments, the asset management system incorporates the environmental and ESG factor (F_ESG) from the hybrid variant of the digital cutoff grade methodology, allowing for quantification of environmental, social, and governance risks. According to embodiments, the environmental and ESG factor is calculated using environmental restriction databases, social opposition incident records, indigenous rights frameworks, and governance compliance assessments, providing a numerical value (e.g., between 0 and 1) that represents ESG-related feasibility. According to embodiments, the asset management system performs digital cutoff grade-ESG correlation analysis that provides quantitative insights into how ESG practices correlate with resource credibility assessments over time, creating a valuation incentive mechanism that reinforces responsible mining practices. The asset management system maintains a continuously updated database of these correlations, enabling it to identify and appropriately value tokenized deposits that demonstrate credibility advantages attributable to sustainable operational practices.

According to embodiments, the asset management system performs operations relating to token burning. According to embodiments, as real world deposits are transformed from unmined to active mining, the asset management system manages the reduction of tokens associated with those real-world assets through a token burning protocol. According to embodiments, the asset management system incorporates production cost data from the Real-Time AISC Index to enable accurate valuation during the transition from unmined to actively mined deposits. Real-world mining data from operational owners is cross-referenced with assay results and independently verified by appointed auditors. This data then engages committed smart contracts requiring multi-signature validation and confirmation from operational, technical, and compliance stakeholders before executing token burns. According to embodiments, real world/real time mining data from operational owners is cross-referenced with assay results and independently verified by appointed auditors. In an embodiment, the data engages the committed smart contracts and may require multi-signature validation and confirmation from operational, technical, and compliance stakeholders before executing token burns. In an embodiment, the token burn may including one or more of the following operations: a) mining data is collected and hashed on-chain, b) a qualified person validates extraction data, c) an independent auditor verify compliance, d) smart contracts include checks for required signatures, and (e) token burn amount is calculated based on verified extraction. According to embodiments, the safety protocols for token burns may also include: a) rate limiting to prevent excessive burns, b) emergency pause functionality, c) minimum time-locks between burns, d) maximum burn amounts per session, and e) multi-signature approval for large burns. In an embodiment, the token burn protocol includes a recovery mechanism in case of operational errors or legal proceedings requirements.

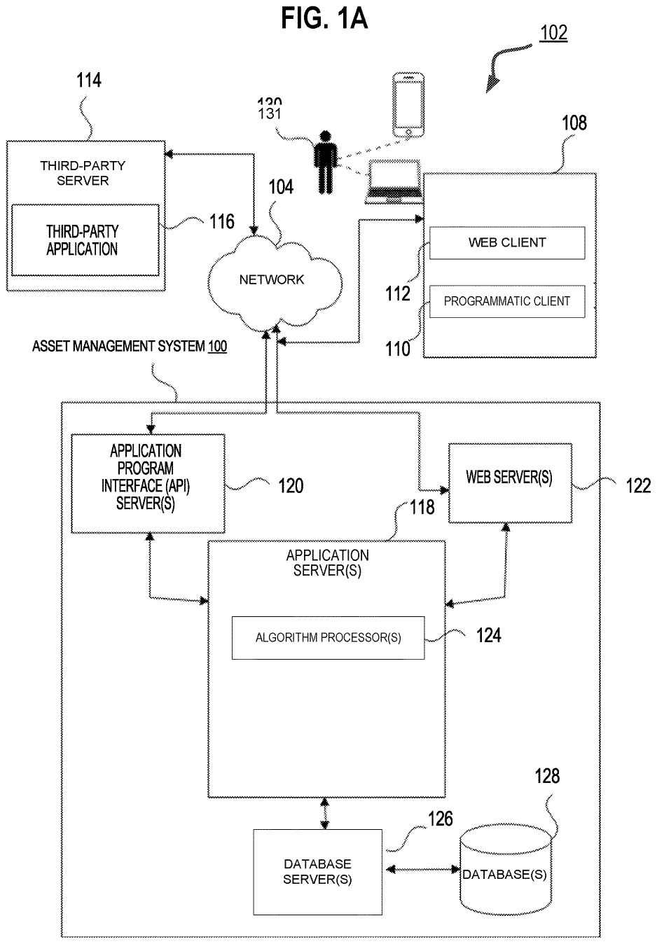

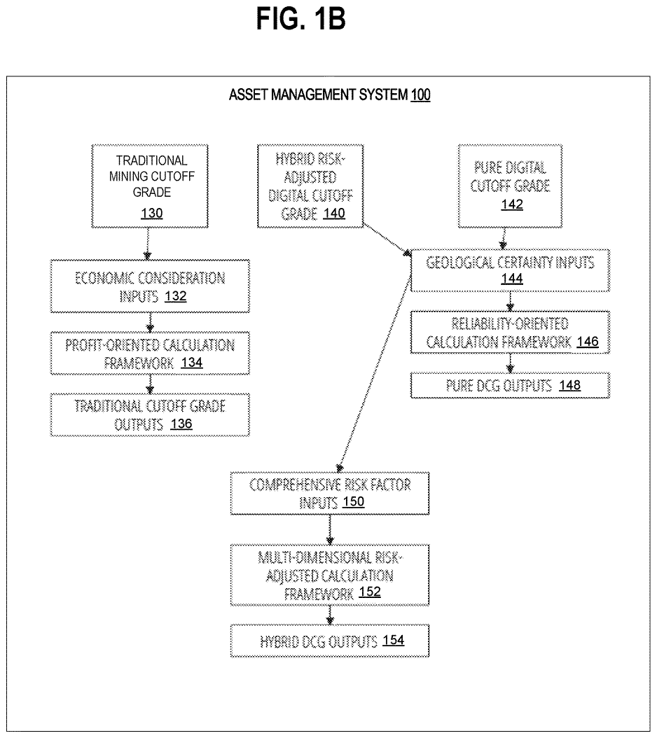

FIG. 1A is a diagrammatic representation of a networked computing environment 102 including an asset management system 100, in accordance with embodiments of the present disclosure. According to embodiments, the asset management system 100 of FIG. 1A is configured to tokenize unmined gold deposits by generating a digital cutoff grade through establishing a target gold content and dividing it by one or more geological confidence factors. According to embodiments, the asset management system 100 uses the digital cutoff grade in a valuation process to calculate a net present value, determine a total quantity of distributable tokens, and issue distributed ledger tokens representing fractional interests in the validated deposit value, as described in greater detail below.

According to embodiments, the asset management system 100 may include one or more computing devices (e.g., application servers such as application server 118) configured to server-side functionality via a network 104 to a networked user device, in the form of a client device 108 that is accessed by a user 131. In an embodiment, a web client 112 (e.g., a browser) and a programmatic client 110 (e.g., an application or “app”) are hosted and executed on the web client 112.

According to embodiments, an application program interface (API) server 120 and a web server 122 provide respective programmatic and web interfaces to the asset management system 100. In an embodiment, the asset management system 100 includes an application server 118 configured to host one or more processing devices (e.g., algorithm processor 124) which includes components, modules and/or applications configured to perform operations, functions, and steps as described in detail below.

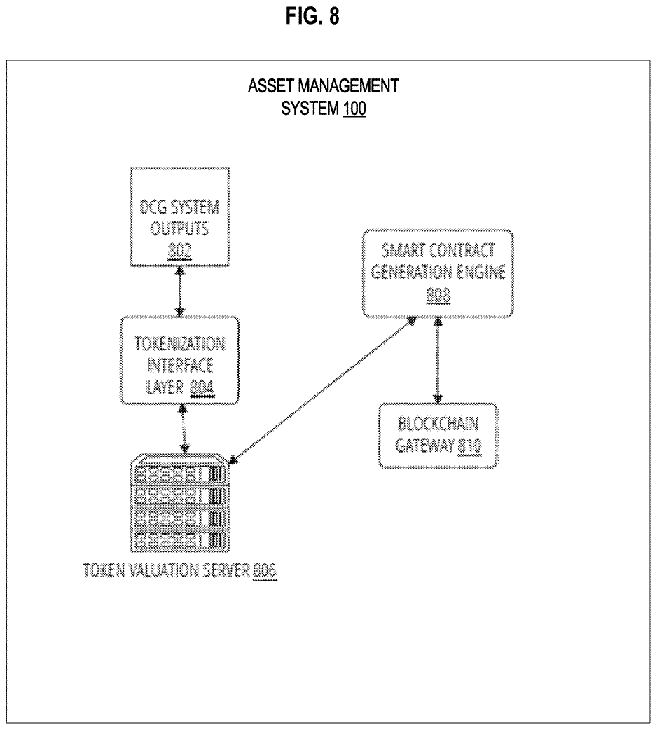

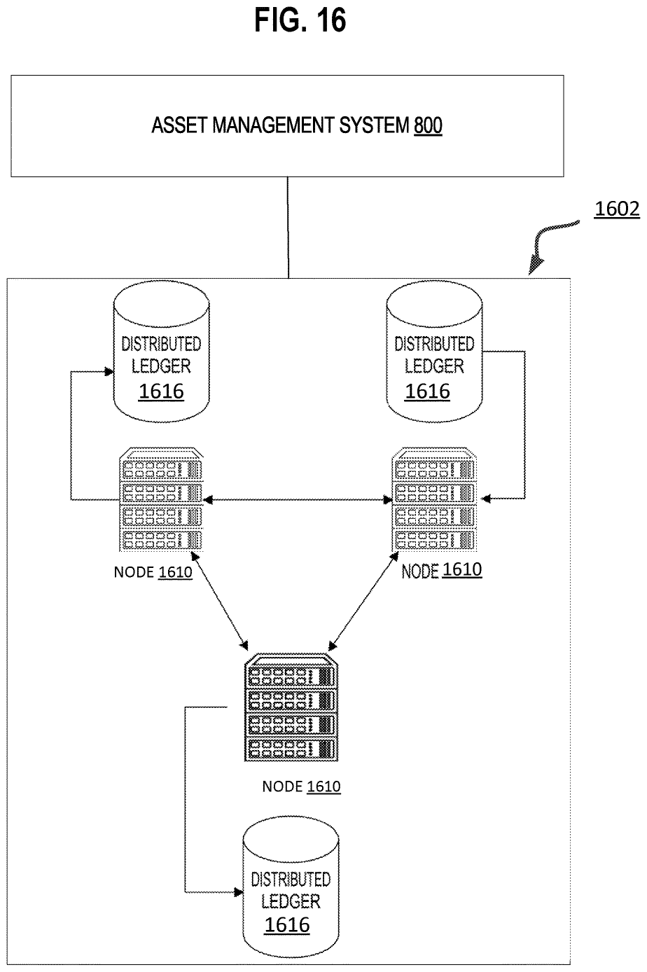

According to embodiments, the web client 112 communicates with the asset management system 100 (e.g., algorithm processor 124 of the asset management system 100) via the web interface supported by the web server 120. In an embodiment, the programmatic client 110 communicates with the asset management system 100 (e.g., algorithm processor 124 of the asset management system 100) via a programmatic interface provided by an API application on the API server 120. The third-party application 816 may, for example, be a distributed ledger (e.g., distributed ledger 1616 of FIG. 16) or a node (e.g., node 810 of FIG. 8) of a third party system configured to register tokens related to unmined gold deposits.

According to embodiments, the one or more application servers 118 of the asset management system 100 are communicatively coupled to one or more database servers 126 that facilitate access to an information storage repository or one or more databases 128. In an example embodiment, the databases 128 may include storage devices that store information to be published and/or processed by the one or more algorithm processors 124 of the asset management system 100.

In an embodiment, a third-party application 116 executing on a third-party server 114, is shown as having programmatic access to the one or more applications servers 118 of the asset management system 100 via the programmatic interface provided by the one or more API server 120. In an embodiment, the third-party application 116 executing on a third-party server 114, is shown as having programmatic access to a user interface (e.g., an environmental considerations user interface) corresponding to an API server 120 of the asset management system 100. According to embodiments, the third-party application 116, using information retrieved from the application server 118, may support one or more features or functions on a website hosted by the third party.

According to embodiments, the asset management system 100 may include one or more modules configured to perform the operations and functions of the methods and processes described in detail below. According to embodiments, the asset management system 100 may include a specialized computing architecture that transforms physical asset documentation into standardized digital representations through a series of technically integrated processes. In an embodiments, the asset management system 100 includes one or more computing devices (e.g., servers) having one or more processors (e.g., algorithm processors 124 of FIG. 1A) configured to execute machine-readable instructions stored in non-transitory computer memory, wherein the instructions cause the processors to perform specific technological operations that solve technical problems in digital asset representation and verification.

According to embodiments, the asset management system 100 incorporates a document processing subsystem that receives and validates proof of title documentation through automated parsing algorithms. The asset management system 100 may employ optical character recognition (OCR) technology combined with natural language processing models to extract and verify ownership information from scanned documents. According to embodiments, the asset management system 100 may execute one or more machine learning models including machine learning classifiers trained to identify specific document types and validate completeness of ownership transfer documentation, reducing manual verification overhead and improving accuracy of title validation processes.

According to embodiments, the asset management system 100 may include a resource verification module configured to process technical documentation compliant with regulatory standards (e.g., NI 43-101 and S-K 1300). In an embodiment, the resource verification module may implement one or more pattern recognition algorithms to identify qualified person signatures, extract resource estimate data, and validate geological survey information. According to embodiments, the asset management system 100 (e.g., the resource verification module) may implement one or more machine learning models trained on historical resource documentation to identify and flag inconsistencies or missing elements in submitted verification materials, enhancing the reliability of resource validation processes.

According to embodiments, the asset management system 100 may include a computational engine that calculates distributable token quantities based on processed resource data. According to embodiments, the computational engine may employ one or more statistical models and risk assessment algorithms that analyze historical extraction probabilities, geological factors, and technical feasibility parameters. In an embodiment, the computational engine of the asset management system 100 may include one or more machine learning regression models trained on mining industry data to predict extraction success rates and adjust token quantities accordingly, providing more accurate representations of underlying asset values.

According to embodiments, the asset management system 100 may include a smart contract generation module configured to create standardized digital tokens with embedded contractual terms. According to embodiments, the smart contract generation module may utilize template-based code generation combined with parameter substitution algorithms to produce blockchain-compatible smart contracts. According to embodiments, the smart contract generation module of the asset management system 100 may employ automated testing frameworks to validate smart contract functionality before deployment, ensuring proper execution of token transfer and rights management operations.

According to embodiments, the asset management system 100 may incorporate a distributed ledger interface that records token issuance across multiple validating nodes. In an embodiment, the distributed ledger interface may implement one or more consensus protocol handlers that manage communication with blockchain networks, ensuring proper transaction validation and immutable record keeping. In an embodiment, the asset management system 100 employ cryptographic hashing algorithms to generate unique token identifiers and maintain data integrity throughout the tokenization process.

According to embodiments, the asset management system 100 may include a wallet management module configured to facilitate electronic wallet operations for token distribution. In an embodiment, the wallet management component may implement multi-signature protocols and secure key management systems to protect token transfers. In an embodiment, the asset management system 100 may employ one or more machine learning anomaly detection models to monitor wallet transactions to identify potentially fraudulent activities, enhancing security of the tokenization platform.

According to embodiments, the asset management system 100 may include a user interface subsystem that provides graphical interfaces for document submission and process monitoring. The user interface subsystem may employ responsive web design frameworks and real-time status update mechanisms to enhance user experience during tokenization operations. In an embodiment, the asset management system 100 may employ one or more machine learning personalization algorithms to adapt interface presentations based on user behavior patterns and preferences.

According to embodiments, the asset management system 100 may include a quality assurance module configured to execute one or more automated validation routines that verify data consistency across processing stages. According to embodiments, the asset management system 100 may include one or more machine learning classification models trained to identify potential errors or inconsistencies in processed documentation, triggering manual review processes when necessary. In an embodiment, the asset management system 100 may implement automated rollback mechanisms to reverse incomplete or erroneous tokenization operations, maintaining data integrity throughout the process.

According to embodiments, the asset management system 100 addresses technical challenges in digital asset creation by providing automated, scalable, and verifiable processes for converting physical asset documentation into blockchain-compatible digital representations. The asset management system 100 integration of machine learning models, cryptographic protocols, and distributed ledger technologies creates a technological solution that improves efficiency, accuracy, and security compared to manual tokenization approaches.

According to embodiments, the asset management system 100 may employ a blockchain including a distributed ledger based on a distributed computing infrastructure that provides immutable record-keeping and cryptographic validation of token transactions through a network of validating nodes, solving the technical problem of establishing verifiable ownership and transferring records for digital asset representations without relying on centralized authorities. According to embodiments, the blockchain implementation employs smart contracts as executable code stored on the distributed ledger that automatically enforce token transfer rules and ownership rights, creating a technological solution that eliminates manual contract enforcement and reduces computational overhead in managing complex multi-party asset transactions.

According to embodiments, the asset management system 100 employs smart contracts for automated compliance and transfer restrictions. According to embodiments, the asset management system 100 provides for integration of regulatory standards (e.g., NI 43-101/S-K 1300) and ESG tracking functionality. In an embodiment, the asset management system 100 employs token burning protocols tied to real-world mining activity and multi-signature validation and deep web transaction mechanisms for security.

According to embodiments, the asset management system 100 provides a secure, legally compliant, and environmentally conscious platform for representing and trading unmined gold deposits in the digital realm. Advantageously, the asset management system addresses and overcomes issues in the digitization and trading of unmined gold deposits by incorporating rigorous verification standards (NI 43-101 and S-K 1300), enabling proper authentication of the resource estimates by qualified persons.

According to embodiments, the asset management system 100 addresses environmental concerns through direct integration of ESG tracking within the smart contract infrastructure, helping ensure mining operations credits aligned with environmental standards. According to embodiments, the asset management system 100 implements a hybrid risk-adjusted digital cutoff grade process that evaluates gold resources through multiple dimensions including geological confidence, accessibility considerations, geopolitical stability analysis, and Environmental, Social, and Governance (ESG) criteria, creating a composite risk profile for more accurate tokenization. According to embodiments, the asset management system resolves security concerns inherent in digital asset trading through innovative transaction mechanisms and multi-signature validation protocols, protecting participants during token exchanges. Advantageously, the asset management system provides a secure, legally compliant, and environmentally conscious system for representing and trading unmined gold deposits in the digital realm.

FIG. 1B illustrates example digital cutoff grade methodologies that may be implemented by the asset management system 100 within the digital resource tokenization framework. According to embodiments, the asset management system 100 is configured to implement multiple different digital cutoff grade generation processes for tokenization valuation, enabling systematic evaluation of unmined gold resources through distinct analytical pathways. The asset management system 100 processes resource data inputs, applies methodology-specific calculations, and generates outputs tailored to the requirements of digital token backing. As shown in FIG. 1B, the asset management system 100 is configured to implement a traditional mining cutoff grade generation process 130, a pure digital cutoff grade generation process 142, and a hybrid risk-adjusted digital cutoff grade generation process 140.

FIG. 1B illustrates multiple parallel pathways representing the distinct methodological approaches executable by the asset management system 100. As shown, the traditional mining cutoff grade generation process 104 begins with economic consideration inputs 132 including operating costs, capital expenditure requirements, commodity price assumptions, and recovery factors. These inputs feed into a profit-oriented calculation framework 134 that determines the minimum economically viable grade based on immediate extraction economics. The resulting traditional cutoff grade outputs 136 include, for example, tonnage-grade curves, economic extraction boundaries, and mine planning parameters optimized for physical extraction.

According to embodiments, the pure DCG generation process 142 begins with geological certainty inputs 144 focused exclusively on resource classification confidence, drilling density, geological model reliability, and geostatistical parameters. These inputs feed into a reliability-oriented calculation framework 146 that determines the minimum reliable grade based solely on geological confidence factors without consideration of economic extraction constraints. The resulting pure DCG outputs 148 include tokenization-ready resource estimates, confidence-adjusted gold content, and geological reliability metrics optimized for digital asset backing.

According to embodiments, the hybrid risk-adjusted digital cutoff grade generation process 140 incorporates both geological certainty inputs 144 and comprehensive risk factor inputs 150. These additional risk inputs include one or more of: accessibility considerations (e.g., depth, infrastructure, technological requirements), geopolitical factors (e.g., jurisdiction stability, regulatory frameworks, resource nationalism), and/or ESG parameters (e.g., environmental restrictions, social license, governance compliance). These combined inputs feed into a multi-dimensional risk-adjusted calculation framework 152 that produces a risk-weighted grade threshold. The resulting hybrid DCG outputs 154 include, for example, one or more of risk-adjusted resource estimates, multi-factor reliability metrics, and/or temporally-calibrated asset backing parameters.

According to embodiments, the asset management system 100 provides specific technical improvements to blockchain-based tokenization systems by implementing the digital cutoff grade methodology within the smart contract architecture. According to embodiments, the smart contracts encode the digital cutoff grade calculations as executable validation logic that automatically enforces minimum ore grade thresholds before permitting token issuance, thereby improving the technical functioning of the distributed ledger system by preventing issuance of tokens that do not meet credibility requirements. According to embodiments, this automated validation reduces computational overhead compared to manual verification processes and improves data integrity across the distributed ledger network.

According to embodiments, the asset management system 100 implements a technical transformation of raw geological resource data into standardized blockchain-compatible digital token representations through a multi-stage data processing pipeline. According to embodiments, the pipeline includes automated ingestion of resource verification documentation, extraction and normalization of geological parameters using natural language processing models, computation of digital cutoff grades through the geological confidence factor calculations, and generation of smart contract code that encodes the computed digital cutoff grade values as on-chain validation parameters. According to embodiments, this automated pipeline solves the technical problem of converting heterogeneous geological data formats into a unified digital representation suitable for distributed ledger recording.

According to embodiments, the asset management system 100 implements specific technical security mechanisms within the smart contract architecture. According to embodiments, the smart contracts implement automated compliance checks that validate resource documentation against regulatory standard templates (e.g., NI 43-101, S-K 1300) before permitting token operations. According to embodiments, the smart contracts enforce role-based access controls that restrict on-chain resource estimate updates to cryptographically authenticated qualified persons. According to embodiments, multi-signature validation protocols require consensus from multiple independent stakeholders (e.g., operational, technical, and compliance) before executing token state changes such as token burns, thereby providing a technical safeguard against unauthorized modifications to the distributed ledger.

According to embodiments, the ESG crediting systems are technically integrated with the smart contract infrastructure through automated oracle-based data feeds that continuously monitor environmental, social, and governance metrics against encoded threshold parameters. According to embodiments, the smart contracts automatically adjust the environmental and ESG factor (F_ESG) used in the hybrid risk-adjusted digital cutoff grade calculation based on real-time ESG data, triggering automated recalculation of token valuations when ESG metrics cross predefined thresholds. According to embodiments, this automated feedback loop between ESG monitoring and token valuation provides a technical improvement to distributed ledger systems by enabling dynamic, data-driven token valuation updates without manual intervention.

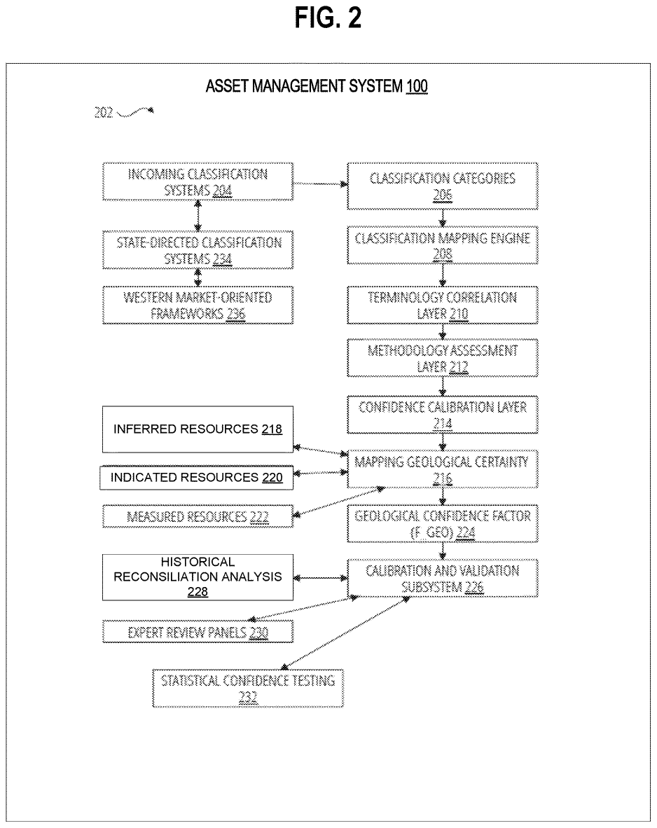

FIG. 2 presents a resource classification mapping framework 202 implemented by the asset management system 100, according to embodiments of the present disclosure. According to embodiments, the asset management system 100 receives information from one or more incoming classification systems 204 represented as parallel input channels (e.g., Western market-oriented frameworks 236 (e.g., JORC (Australia), NI 43-101 (Canada), SAMREC (South Africa), PERC (Europe), and/or SME (United States)) and state-directed classification systems 234 including, for example, Russian GKZ standards, Chinese CMREC specifications, Kazakhstan's KazRC code, and other nation-specific methodologies. According to embodiments, each classification system 234, 236 may employ its own terminology, confidence criteria, and methodological approaches represented by their unique classification categories 206.

According to embodiments, the asset management system 100 includes a classification mapping engine 208 that implements a sophisticated harmonization process through multiple analytical layers (e.g., executable using one or more machine learning models). According to an embodiment, the classification mapping engine 208 includes a terminology correlation layer 210 that identifies semantic equivalences between classification terms across different systems (e.g., systems 234, 236). According to an embodiment, the classification mapping engine 208 further includes a methodology assessment layer 212 that evaluates the underlying technical criteria used to assign classifications in each system. According to an embodiment, the classification mapping engine 208 also includes a confidence calibration layer 214 that quantifies the relative stringency of different classification frameworks to establish equivalence parameters.

According to embodiments, the asset management system 100 executes a mapping process to map geological certainty factors 216 with the DCG calculation requirements. In an embodiment, standardized categories may be employed, including, for example, a measured resources 222 category representing the highest confidence level, an indicated resources 220 category representing a moderate confidence level, and an inferred resources 218 category representing a lowest confidence level. According to embodiments, each standardized category is associated with a specific geological confidence factor (F_geo) 224 value used directly in the DCG calculations.

According to embodiments, the asset management system 100 includes a calibration and validation subsystem 226 that ensures mapping accuracy through one or more verification mechanisms. According to embodiments, the calibration and validation subsystem 226 performs historical reconciliation analysis 228 that compares mapped classifications with actual mining outcomes to validate alignment. According to embodiments, the calibration and validation subsystem 226 may incorporate expert review panels 230 that provide human oversight of the mapping logic, and performs statistical confidence testing 232 that quantifies the reliability of the mapping correlations.

According to embodiments, the resource classification mapping framework 202 of the asset management system 100 enables the processing of resource reports from diverse global sources and regulatory environments, creating a standardized basis for consistent DCG calculations irrespective of the original reporting methodology.

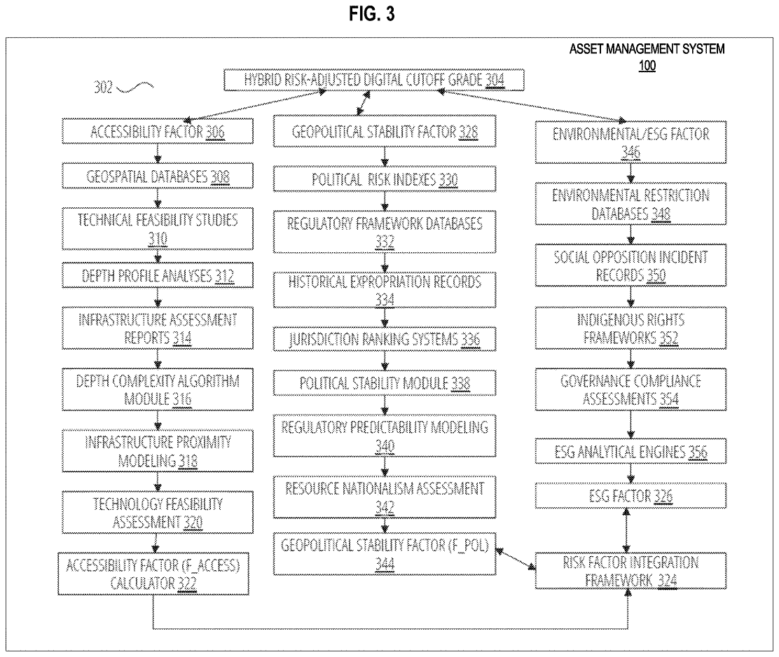

FIG. 3 illustrates the asset management system 100 executing a hybrid risk-adjusted digital cutoff grade generation process 302, according to embodiments of the present disclosure. According to embodiments, the asset management system 100 is configured to transform qualitative risk assessments into numerical factors used in the hybrid risk-adjusted digital cutoff grade calculations.

According to embodiments, the hybrid risk-adjusted digital cutoff grade generation process 302 begins with separate risk dimension pathways corresponding to example non-geological risk categories incorporated in the hybrid DCG calculation. According to embodiments, each pathway includes specialized data acquisition modules, analytical processes, and quantification frameworks implemented by the asset management system 100.

According to embodiments, the asset management system 100 includes an accessibility factor pathway 306 that processes inputs from multiple data sources (e.g., geospatial databases 308 containing terrain and infrastructure information, technical feasibility studies 310 documenting extraction complexity, depth profile analyses 312 quantifying vertical resource distribution, and infrastructure assessment reports 314 that evaluate transportation and utility availability). According to embodiments, these inputs undergo analytical processing through a depth complexity algorithm module 316, an infrastructure proximity modeling module 318, and a technology feasibility assessment module 320. According to embodiments, the combined outputs feed into an accessibility factor (F_access) calculator 322 that produces a numerical value between 0 and 1 representing resource accessibility.

According to embodiments, the asset management system 100 includes a geopolitical stability factor pathway 328 that incorporates data from political risk indexes 330, regulatory framework databases 332, historical expropriation records 334, and jurisdiction ranking systems 336. According to embodiments, these inputs are processed through a political stability module 338, a regulatory predictability modeling module 340, and a resource nationalism assessment module 342. According to embodiments, the analytical outputs generate a geopolitical stability factor (F_pol) 344 through a weighted formula that produces a numerical value (e.g., between 0 and 1) representing jurisdictional reliability.

According to embodiments, the asset management system 100 includes an environmental/ESG factor pathway 346 that utilizes inputs from environmental restriction databases 348, social opposition incident records 350, indigenous rights frameworks 352, and governance compliance assessments 354. According to embodiments, these data sources feed ESG analytical engines 356 including environmental sensitivity modeling, social license quantification, and governance compliance assessment modules. According to embodiments, the processed outputs combine in an ESG factor calculator 326 to generate a numerical value (e.g., between 0 and 1) representing ESG-related feasibility.

According to embodiments, the asset management system 100 includes a risk factor integration framework 324 that combines the outputs from all risk pathways into a coherent composite credibility factor. According to embodiments, the risk factor integration framework 324 identifies relationships between different risk dimensions, while a temporal calibration engine adjusts risk factors based on projected timeframes for resource utilization. According to embodiments, a composite visualization module generates multi-dimensional representations of the complete risk profile (e.g., using radar charts and heat maps) to support intuitive understanding of complex risk landscapes.

According to embodiments, the asset management system 100 includes a continuous calibration system that refines risk quantification accuracy through ongoing feedback loops. According to embodiments, a historical outcome analysis module compares risk predictions with actual mining challenges, while an expert validation framework incorporates human oversight to ensure realistic assessments. According to embodiments, a machine learning optimization module continuously improves quantification algorithms based on accumulating data and outcomes.

According to embodiments, the hybrid risk-adjusted digital cutoff grade generation process 302 executed by the asset management system 100 enables the conversion of qualitative assessments of accessibility challenges, geopolitical risks, and ESG concerns into precise numerical factors that can be directly incorporated into the hybrid DCG calculation formula.

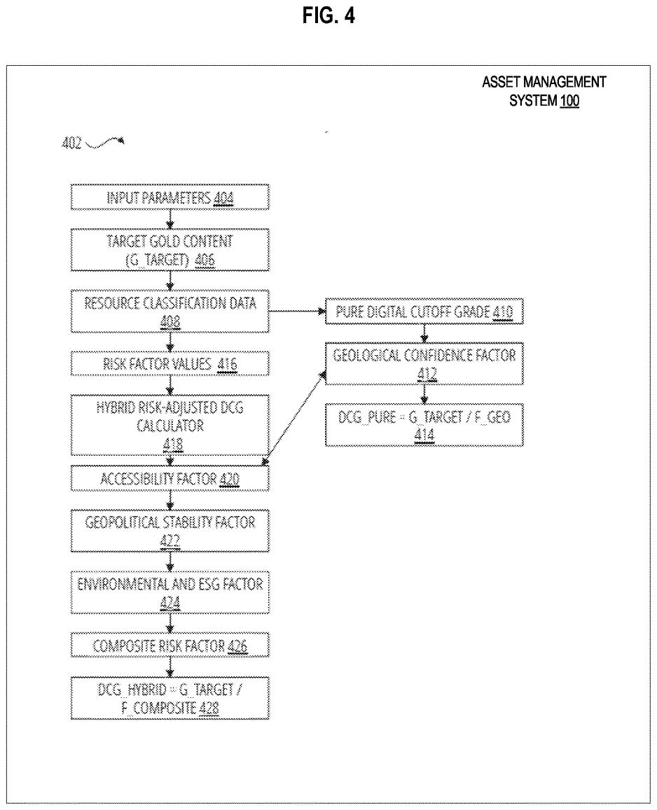

FIG. 4 illustrates the asset management system 100 executing digital cutoff grade calculation processes 402, according to embodiments of the present disclosure. According to embodiments, the asset management system 100 is configured to implement transformational algorithms and computational workflows that form the calculation engines for determining digital cutoff grades for tokenization valuation.

According to embodiments, the asset management system 100 receives input parameters 410 required for all DCG calculations. According to embodiments, these input parameters 410 include a target gold content (G_target) specification 412 representing the desired effective gold content per ton necessary for token backing, resource classification data 414 containing tonnage and grade information categorized by confidence level, and risk factor values 416 when implementing the hybrid methodology.

According to embodiments, the asset management system 100 includes a pure digital cutoff grade calculation pathway 420 that implements a focused mathematical model based solely on geological confidence. According to embodiments, the pure digital cutoff grade calculation pathway 420 begins with a geological confidence factor assignment module 422 that maps standardized resource classifications to corresponding F_geo values (e.g., Measured=0.8, Indicated=0.4, Inferred=0.2). According to embodiments, a pure DCG formula implementation module 424 applies the following expression:

DCG_pure=G_target/F_geo

According to embodiments, this calculation produces a minimum ore grade required for each resource classification to provide reliable token backing based exclusively on geological certainty. According to embodiments, the pure digital cutoff grade calculation pathway 420 includes validation checks 426 that ensure results fall within geologically reasonable parameters and documentation generation 428 that records all calculation steps for transparency.

According to embodiments, the asset management system 100 includes a hybrid risk-adjusted DCG calculator 418 that implements a model incorporating multiple risk dimensions. According to embodiments, the hybrid risk-adjusted DCG calculator 418 begins with multiple factor assignment operations (e.g., geological confidence factor 412, accessibility factor 420, geopolitical stability factor 422, and environmental and ESG factor 424). According to embodiments, these factors combine in a composite risk factor module 426 through the following operation:

F_composite=F_geo×F_access×F_pol×F_ESG

According to embodiments, the hybrid risk-adjusted DCG calculator 418 then applies the mathematical relationship:

DCG_hybrid=G_target/F_composite

According to embodiments, this calculation produces a risk-adjusted minimum ore grade required to provide reliable token backing. According to embodiments, the hybrid risk-adjusted DCG calculator 418 includes a sensitivity analysis module that quantifies how changes in individual risk factors affect the final DCG value and an uncertainty quantification module that establishes confidence intervals for the results.

According to embodiments, the digital cutoff grade calculation processes 402 executed by the asset management system 100 enable the systematic determination of minimum ore grades required for gold deposits to qualify as credible backing for digital tokens, using either geological-only or multi-factor risk-adjusted methodologies.

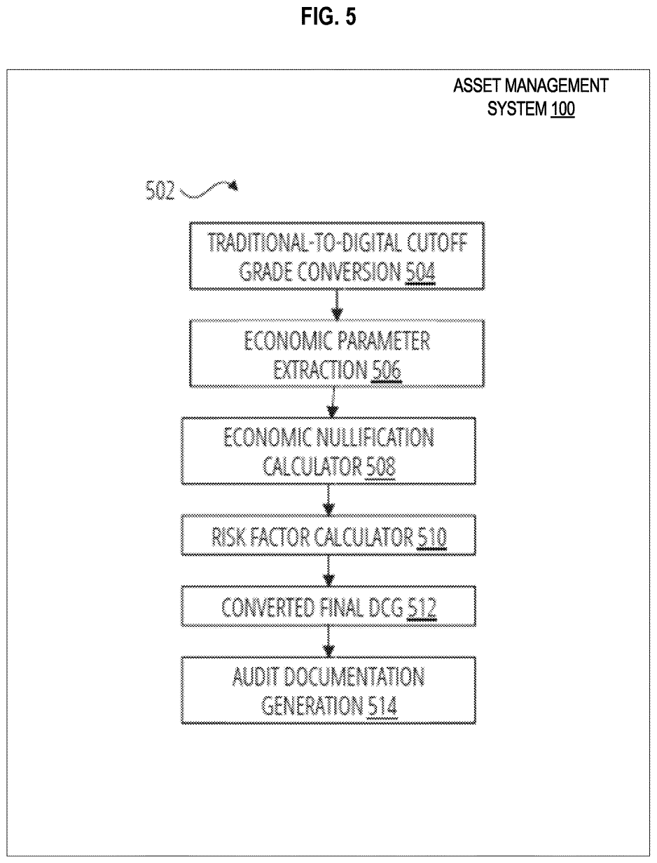

FIG. 5 illustrates the asset management system 100 configured to execute a traditional-to-digital cutoff grade conversion process 502, according to embodiments of the present disclosure. According to embodiments, the asset management system 100 is configured to implement economic removals and nullifications for adapting existing mining cutoff grades to tokenization purposes.

According to embodiments, the traditional-to-digital cutoff grade conversion process 502 begins with an economic parameter extraction module 506 that identifies the financial assumptions underlying the traditional cutoff grade. According to embodiments, the asset management system 100 includes an economic nullification calculator 508 that systematically removes these considerations to apply the following expression:

CG_nullified=CG_traditional×(P_assumed/P_reference)×(C_reference/C_assumed)

According to embodiments, P_assumed and C_assumed represent the price and cost assumptions in the original calculation, while P_reference and C_reference represent standardized reference values.

According to embodiments, the asset management system 100 includes a risk factor calculator 510 that incorporates appropriate confidence and risk factors to produce a converted final DCG 512, in accordance with the following expression:

DCG_converted=CG_nullified/F_composite

According to embodiments, the traditional-to-digital cutoff grade conversion process 502 includes an audit documentation generation module 514 that records all transformation steps for auditability.

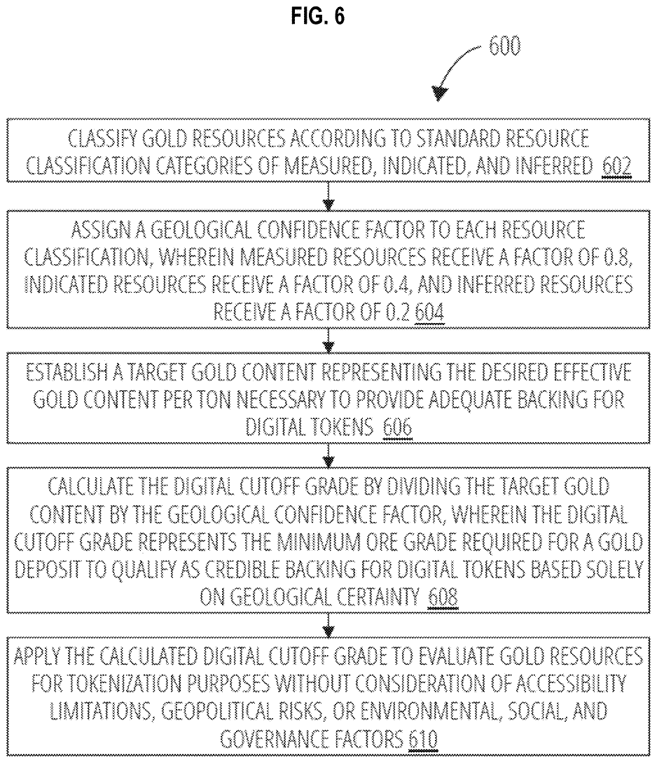

FIG. 6 is a flow diagram illustrating an example pure digital cutoff grade generation process 600 executable by the asset management system 100, according to embodiments of the present disclosure. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

According to embodiments, in step 602, the asset management system 100 classifies gold resources according to standard resource classification categories of measured, indicated, and inferred. According to embodiments, in step 604, the asset management system 100 assigns a geological confidence factor to each resource classification. According to embodiments, the asset management system 100 assigns a factor of 0.8 to resources having a measured resource classification, assigns a factor of 0.4 to resources having an indicated resource classification, and assigns a factor of 0.1 to resources having an inferred resource classification.

According to embodiments, in step 606, the asset management system 100 establishes a target gold content representing the desired effective gold content per ton necessary to provide adequate backing for digital tokens. According to embodiments, in step 608, the asset management system 100 calculates the digital cutoff grade by dividing the target gold content by the geological confidence factor, wherein the digital cutoff grade represents the minimum ore grade required for a gold deposit to qualify as credible backing for digital tokens based solely on geological certainty. According to embodiments, in step 610, the asset management system 100 applies the calculated digital cutoff grade to evaluate gold resources for tokenization purposes without consideration of accessibility limitations, geopolitical risks, or environmental, social, and governance factors.

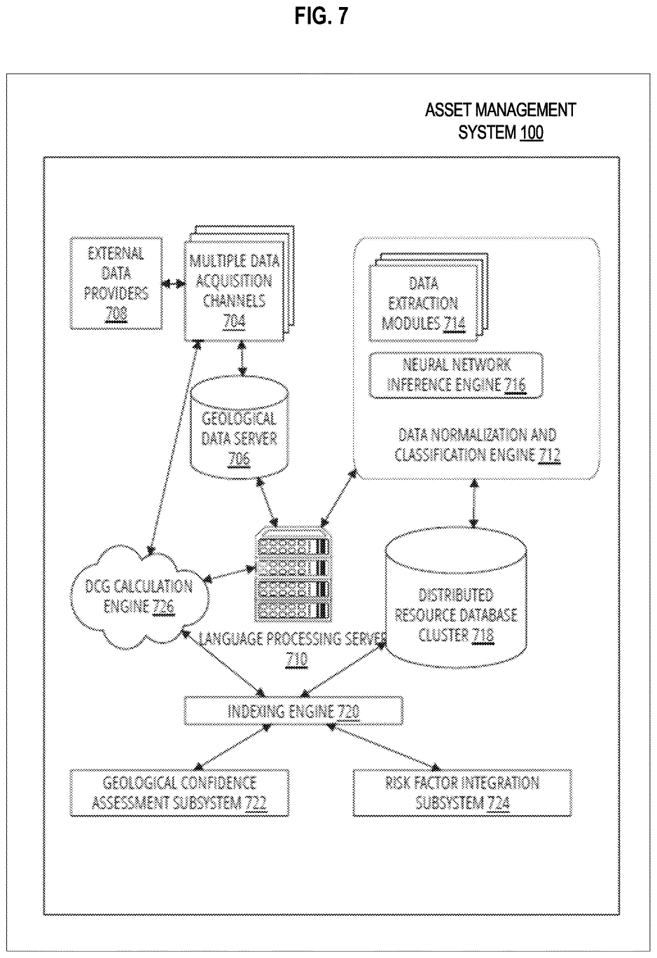

FIG. 7 illustrates a hardware and data flow architecture 702 implemented by the asset management system 100 to process diverse resource data inputs and calculate both pure digital cutoff grades and hybrid risk-adjusted digital cutoff grades within a tokenization environment, according to embodiments of the present disclosure.

According to embodiments, the asset management system 100 includes multiple data acquisition channels 704 designed to ingest diverse resource information. According to embodiments, a geological data server 706 maintains a secure connection to multiple external data providers 708 (e.g., mining company databases, regulatory repositories, and third-party resource assessment services). According to embodiments, these connections are maintained through secure API gateways in the multiple data acquisition channels 704 utilizing encryption to ensure data integrity during transmission. According to embodiments, a language processing server 710 houses natural language processing engines optimized for extracting structured resource data from unstructured technical documents in multiple languages and reporting frameworks.

According to embodiments, the asset management system 100 includes a data normalization and classification engine 712, which comprises a high-throughput preprocessing server equipped with data extraction modules 714. According to embodiments, the data extraction modules 714 implement rule-based algorithms specifically calibrated for various national resource reporting formats (e.g., JORC, NI 43-101, SAMREC, GKZ, and CMREC specifications). According to embodiments, the preprocessing server interfaces with a neural network inference engine 716 running on tensor processing units (TPUs) optimized for language translation and technical terminology recognition. According to embodiments, the neural network inference engine 716 maps diverse resource classification terminologies to standardized categories required for DCG calculations.

According to embodiments, the asset management system 100 includes a distributed resource database cluster 718, which implements a fault-tolerant, high-availability architecture spread across redundant storage nodes. According to embodiments, the database employs a purpose-built schema designed to maintain provenance chains validating the authenticity, traceability, and transparency of the calculation. According to embodiments, the database tracks all transformations applied to original resource data. According to embodiments, an indexing engine 720 maintains multidimensional indices optimized for rapid resource queries based on geographic location, deposit type, classification confidence, and other critical parameters.

According to embodiments, for pure digital cutoff grade calculations, the asset management system 100 routes data to a geological confidence assessment subsystem 722. According to embodiments, the geological confidence assessment subsystem 722 leverages a high-performance geological modeling server that implements custom algorithms for evaluating resource certainty based solely on geological factors. According to embodiments, the modeling server interfaces with a statistical analysis engine that quantifies confidence intervals and calculates geological confidence factors (F_geo) for resource classifications. According to embodiments, a parallel computation farm with multiple compute nodes executes Monte Carlo simulations that generate probabilistic resource models, providing a mathematical basis for uncertainty quantification.

According to embodiments, for hybrid risk-adjusted DCG calculations, the asset management system 100 incorporates additional data streams through a risk factor integration subsystem 724. According to embodiments, the risk factor integration subsystem 724 includes a geospatial analysis server that evaluates physical accessibility factors through terrain modeling, infrastructure proximity mapping, and extraction complexity analysis. According to embodiments, a geopolitical intelligence engine aggregates data from multiple political risk data providers, regulatory frameworks databases, and global mining governance sources to calculate geopolitical stability factors (F_pol). According to embodiments, an ESG assessment module processes environmental monitoring data, social license indicators, and governance compliance metrics to generate environmental and ESG factors (F_ESG). According to embodiments, these specialized risk engines store their outputs in a time-series risk database that maintains historical risk factor data to support trend analysis.

According to embodiments, the asset management system 100 includes a DCG calculation engine 726 that implements the computational management of the system. According to embodiments, the DCG calculation engine 726 comprises a distributed computing cluster incorporating multiple calculation nodes running parallel processing algorithms optimized for matrix operations. According to embodiments, the DCG calculation engine 726 implements both the pure DCG methodology through the geological confidence assessment subsystem 722 and the hybrid risk-adjusted methodology through the risk factor integration subsystem 724. According to embodiments, a verification server implements redundant calculation pathways to ensure computational accuracy and detect any anomalies in the calculation process.

FIG. 8 is a block diagram illustrating a tokenization output process 802 executable by the asset management system 100, according to embodiments of the present disclosure. According to embodiments, the asset management system 100 includes a tokenization interface layer 804 that prepares calculated DCG values for integration with blockchain networks. According to embodiments, the asset management system 100 includes a token valuation server 806 that applies DCG values to resource tonnage and grade data to calculate risk-adjusted token backing metrics. According to embodiments, the asset management system 100 includes a smart contract generation engine 808 that produces executable code implementing DCG-based valuation logic directly on blockchain platforms. According to embodiments, the asset management system 100 includes a blockchain gateway 810 that maintains secure connections to multiple distributed ledger networks, supporting various tokenization protocols.

According to embodiments, the asset management system 100 includes a token valuation server 806 that applies DCG values to resource tonnage and grade data to calculate risk-adjusted token backing metrics. According to embodiments, the asset management system 100 includes a smart contract generation engine 808 that produces executable code implementing DCG-based valuation logic directly on blockchain platforms. According to embodiments, the asset management system 100 includes a blockchain gateway 810 that maintains secure connections to multiple distributed ledger networks, supporting various tokenization protocols.

According to embodiments, the asset management system 100 includes an operational management layer 812 that implements system-wide monitoring and security. According to embodiments, the operational management layer 812 includes a central administrator console that provides authorized personnel with visualization tools and control interfaces for all system components. According to embodiments, the operational management layer 812 includes a security enforcement server that implements role-based access controls, activity logging, and intrusion detection across all subsystems. According to embodiments, the operational management layer 812 includes an audit tracking database that maintains records of all system operations, ensuring regulatory compliance and full transparency of the DCG calculation process.

According to embodiments, the asset management system 100 processes continuous data streams from mining operations worldwide, normalizing diverse resource reports into a standardized format. According to embodiments, for pure digital cutoff grade calculations, the asset management system 100 utilizes only the geological components of the system, focusing exclusively on geological certainty parameters. According to embodiments, for hybrid risk-adjusted calculations, the asset management system 100 leverages the full system architecture, incorporating the additional risk assessment modules to generate risk profiles.

According to embodiments, for traditional-to-digital cutoff grade conversions, the asset management system 100 incorporates a specialized conversion pipeline 814. According to embodiments, the conversion pipeline 814 includes a mining economics analysis engine 816 designed to process traditional cutoff grade calculations and extract the underlying economic assumptions. According to embodiments, the conversion pipeline 814 includes a nullification module 818 that systematically removes economic extraction parameters while preserving geological certainty data. According to embodiments, the conversion pipeline 814 includes a conversion logic server 820 that integrates risk factors as appropriate to generate DCG values calibrated to tokenization requirements.

According to embodiments, the asset management system 100 is configured to perform a method for determining a digital cutoff grade for tokenization of unmined gold resources, including: classifying gold resources according to standard resource classification categories of measured, indicated, and inferred; assigning a geological confidence factor to each resource classification, wherein measured resources receive a factor of 0.8, indicated resources receive a factor of 0.4, and inferred resources receive a factor of 0.2; establishing a target gold content representing the desired effective gold content per ton necessary to provide adequate backing for digital tokens; calculating the digital cutoff grade by dividing the target gold content by the geological confidence factor, wherein the digital cutoff grade represents the minimum ore grade required for a gold deposit to qualify as credible backing for digital tokens based solely on geological certainty; and applying the calculated digital cutoff grade to evaluate gold resources for tokenization purposes without consideration of accessibility limitations, geopolitical risks, or environmental, social, and governance factors.

According to embodiments, the asset management system 100 is configured to perform a method for determining a risk-adjusted digital cutoff grade for tokenization of unmined gold resources, including: classifying gold resources according to standard resource classification categories and assigning corresponding geological confidence factors; evaluating physical accessibility of resources by analyzing depth, technological feasibility, infrastructure presence, and extraction readiness to derive an accessibility factor; assessing geopolitical conditions including political stability, regulatory frameworks, resource nationalism risks, and jurisdictional control to determine a geopolitical stability factor; analyzing environmental, social, and governance considerations including environmental restrictions, social opposition, and regulatory compliance to establish an environmental and ESG factor; establishing a target gold content representing the desired effective gold content per ton necessary to provide adequate backing for digital tokens; calculating a composite risk factor by multiplying the geological confidence factor, accessibility factor, geopolitical stability factor, and environmental and ESG factor; and determining the digital cutoff grade by dividing the target gold content by the composite risk factor, wherein the digital cutoff grade represents the minimum ore grade required for a gold deposit to qualify as credible backing for digital tokens based on an assessment of resource reliability.

According to embodiments, the asset management system 100 is configured to perform a method for converting traditional mining cutoff grades to digital cutoff grades for tokenization of unmined gold resources, including: identifying a gold deposit with an established traditional cutoff grade based on operating costs, processing costs, metal prices, and recovery rates; nullifying economic extraction cost considerations by resetting the traditional cutoff grade to zero to reflect the absence of immediate physical mining requirements for tokenization; determining applicable risk factors including a geological confidence factor based on resource classification, an accessibility factor based on physical access limitations, a geopolitical stability factor based on political and regulatory risks, and an environmental and ESG factor based on environmental and social considerations; calculating a composite credibility factor by multiplying all applicable risk factors to represent the overall reliability of the resource; establishing a target gold content representing the desired effective gold content per ton necessary to provide adequate backing for digital tokens; adjusting the target gold content based on the composite credibility factor; and determining the digital cutoff grade by dividing the adjusted target gold content by the composite credibility factor, wherein the digital cutoff grade provides a systematic framework for transitioning from conventional mining economics to digital asset valuation.

According to embodiments, the asset management system 100 is configured to perform a method for determining and tokenizing the value of verified unmined gold deposits, including: receiving, via a graphical user interface (GUI) into a server computer (e.g., a computing device of the asset management system), proof of title and ownership rights to at least one verified gold deposit in at least one specified location, along with documentation of unencumbered transfer of associated rights and interests; receiving, via the GUI into the server computer, resource verification documentation compliant with NI 43-101 or S-K 1300 standards for the verified gold deposit, including drill data, assay results, and geological models; calculating a digital cutoff grade for the deposit by: establishing a target gold content representing the desired effective gold content necessary to provide adequate backing for digital tokens; assigning a geological confidence factor to each resource classification, wherein measured resources receive a factor of 0.8, indicated resources receive a factor of 0.4, and inferred resources receive a factor of 0.2; dividing the target gold content by the geological confidence factor to determine the minimum ore grade required for the gold deposit to qualify as credible backing for digital tokens; calculating, with the server computer, a net present value for the deposit by applying resource classification multipliers of 0.8 for measured resources, 0.4 for indicated resources, and 0.2 for inferred resources; determining, with the server computer, a total quantity of distributable tokens by dividing the calculated net present value by a standardized unit value, with the unit value derived from market comparable transactions for similar deposits; receiving, via the GUI into the server computer, validation of the value calculations from a qualified person as defined under NI 43-101 or S-K 1300; issuing, with the server computer, distributed ledger tokens representing fractional interests in the validated deposit value, with each token incorporating a smart contract that comprises references to the underlying resource calculations and technical assumptions, establishes mechanisms for value updates based on new technical data or market conditions, and defines token holder rights regarding value realization; recording the token issuance and underlying valuations in a distributed ledger maintained across validating nodes; and crediting the initial quantity of value-backed tokens to the titleholder's electronic wallet.

According to embodiments, the asset management system 100 is further configured to perform a method including: evaluating accessibility considerations, geopolitical stability, and environmental, social, and governance factors for the gold deposit; calculating a composite credibility factor by multiplying the geological confidence factor with quantified factors for accessibility, geopolitical stability, and ESG considerations; determining a hybrid risk-adjusted digital cutoff grade by dividing the target gold content by the composite credibility factor; and applying the hybrid risk-adjusted digital cutoff grade to evaluate gold resources for tokenization purposes.

According to embodiments, the asset management system 100 is further configured to perform a method including: adapting a traditional technical report for digital tokenization by: standardizing resource classifications from diverse national reporting formats; replacing traditional economic cutoff grades with calculated digital cutoff grades; adding tokenization-specific sections addressing valuation methodologies, update mechanisms, and digital asset-specific risk disclosures; and maintaining an audit trail of all transformations applied to the original report data.

According to embodiments, the asset management system 100 is configured to perform a method for amending technical reports for digital tokenization of unmined gold deposits, including: receiving a technical report compliant with NI 43-101 or S-K 1300 standards; extracting resource classification tables, economic assumptions, and risk factors; calculating digital cutoff grades using at least one of: pure digital cutoff grade methodology based solely on geological confidence, hybrid risk-adjusted methodology incorporating multiple risk dimensions, or conversion methodology that transforms traditional cutoff grades; generating revised resource tables showing both traditional and DCG-adjusted resource estimates; adding new sections addressing tokenization considerations; and obtaining validation from a qualified person for the amended technical report.

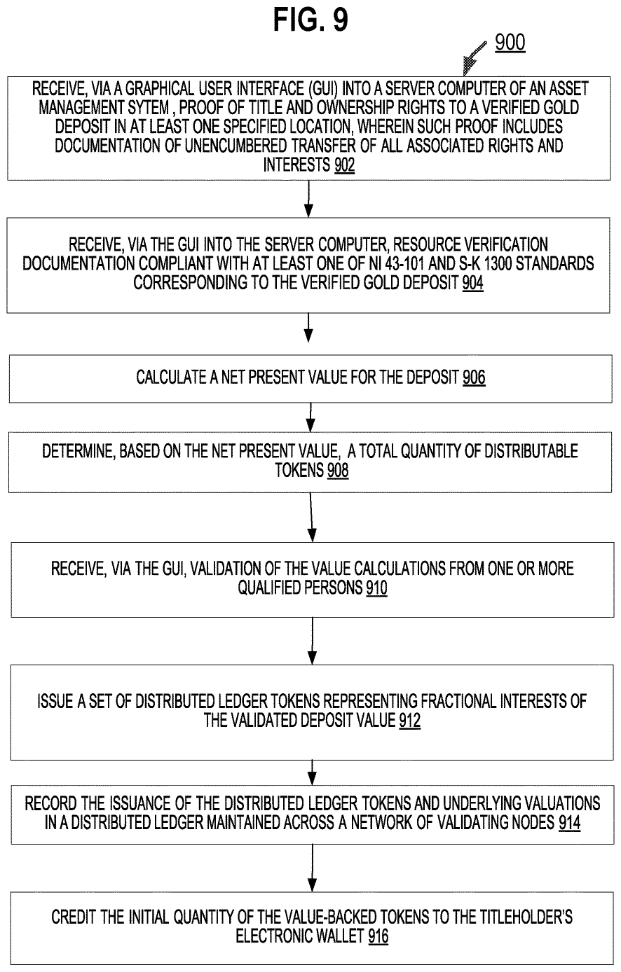

FIG. 9 is a flow diagram of an example method 900 executable by an asset management system (e.g., asset management system 100) to generate a valuation for one or more assets, such as a verified unmined gold deposits, according to embodiments of the present disclosure. According to embodiments, the method 900 includes steps and operations to determine and tokenize a value of verified unmined gold deposits (also referred to as “valuation method 900”). The method 900 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In step 902, the valuation method 900 receives, via a graphical user interface (GUI) into a processing device (e.g., one or more processing devices of a server computer of an asset management system), proof of title and ownership rights to a verified gold deposit in a specified location. According to embodiments, the proof of title and ownership rights includes documentation of unencumbered transfer of all associated rights and interests. In step 904, the valuation method 900 receives, via the GUI, resource verification documentation compliant with one or more standards (e.g., at least one of NI 43-101 and S-K 1300 standards) corresponding to the verified gold deposit. In an embodiment, the resource verification documentation includes one or more of drill data, assay results, or geological models.

In step 906, the valuation method 900 calculates (e.g., with a processing device of a server computer of the asset management system) a net present value for the deposit. In an embodiment, the net present value is calculated by applying one or more resource classification multipliers for the resources based on a resource type. For example, a first resource classification multiplier (e.g., 0.8) may be applied for measured resources (e.g., a first resource type), a second resource classification multiplier (e.g., 0.4) may be applied for indicated resources (e.g., a second resource type), and a third resource classification multiplier (e.g., 0.2) may be applied for inferred resources (e.g., a third resource type).

In an embodiment, calculating the net present value may include the incorporation or consideration of one or more technical modifying factors (e.g., recovery rates, dilution, processing costs, etc.). In an embodiment, calculating the net present value may include projecting operating costs and/or capital expenditures over the corresponding mine life associated with the asset. In an embodiment, calculating the net present value may include forecasting revenue streams using commodity price projections. In an embodiment, calculating the net present value may include applying jurisdiction-specific discount rates reflecting permitting and development timelines.

In step 908, the valuation method 900 determines, based on the net present value, a total quantity of distributable tokens. According to embodiments, the total quantity of distributable tokens is determined by dividing the calculated net present value by a standardized unit value. In an embodiment, the standardized unit value is derived from market comparable transactions for similar deposits.

In step 910, the valuation method 900 receives validation of the value calculations from one or more qualified persons (e.g., qualified persons as defined under an applicable standard such as the NI 43-101 standard and/or the S-K 1300 standard).

In step 912, the valuation method 900 issues a set of distributed ledger tokens representing fractional interests of the validated deposit value. In an embodiment, each distributed ledger token incorporates a smart contract. In an embodiment, each smart contract includes one or more references to the underlying resource calculations, one or more references to one or more technical assumptions. In an embodiment, each smart contract establishes mechanisms for value updates based on new technical data or market conditions. In an embodiment, each smart contract defines token holder rights regarding value realization.

In step 914, the valuation method 900 records the token issuance and underlying valuations in a distributed ledger maintained across a network or set of validating nodes. In step 916, the valuation method 900 credits the initial quantity of the value-backed tokens to an electronic wallet associated with (e.g., owned by) the titleholder. In an embodiment, the initial quantity of the issued distributed ledger tokens are credited to the titleholder by transferring the distributed ledger tokens to an electronic wallet owned by the titleholder.

According to embodiments, FIG. 9 illustrates a valuation method 900 relating to the valuation, tokenization, and issuance of underlying valuations of a single gold deposit. According to embodiments, the valuation method 900 may be executed to generate a valuation and tokenize any number of gold deposits. According to embodiments, the valuation method 900 may be executed to establish a fungible token that represents a fractional value related to a plurality of total unmined gold deposits across a plurality of locations.

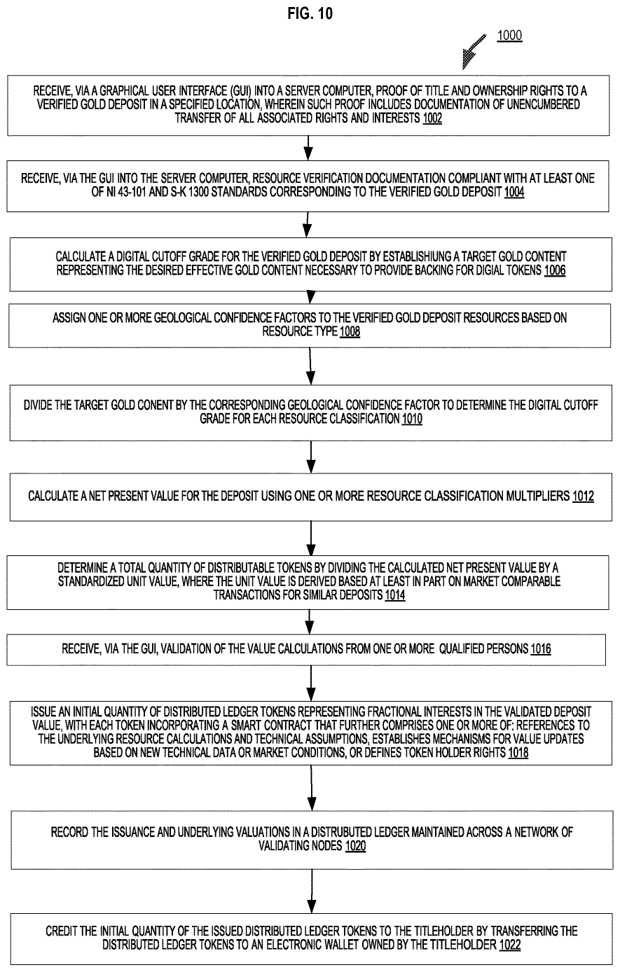

FIG. 10 is a flow diagram of an example method 1000 executable by an asset management system (e.g., asset management system 100 of FIG. 1) to tokenize verified unmined gold deposits using a digital cutoff grade, according to embodiments of the present disclosure. The method 1000 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In step 1002, the tokenization method 1000 receives, via a graphical user interface (GUI) into a server computer, proof of title and ownership rights to at least one verified gold deposit in at least one specified location, along with documentation of unencumbered transfer of associated rights and interests. In step 1004, the tokenization method 1000 receives, via the GUI into the server computer, resource verification documentation compliant with one or more standards (e.g., at least one of NI 43-101 and S-K 1300 standards) for the verified gold deposit. In an embodiment, the resource verification documentation includes one or more of drill data, assay results, or geological models.

In step 1006, the tokenization method 1000 calculates (e.g., with a processing device of a server computer) a digital cutoff grade for the verified gold deposit by establishing a target gold content representing the desired effective gold content necessary to provide backing for digital tokens. In step 1008, in an embodiment, the tokenization method 1000 assigns geological confidence factors of 0.8 for measured resources, 0.4 for indicated resources, and 0.2 for inferred resources. In step 1010, the tokenization method 1000 segments or divides the target gold content by the appropriate geological confidence factor to determine the digital cutoff grade for each resource classification.

In step 1012, the tokenization method 1000 calculates (e.g., with a processing device of a server computer) a net present value for the deposit by applying resource classification multipliers of 0.8 for measured resources, 0.4 for indicated resources, and 0.2 for inferred resources. In step 1014, the tokenization method 1000 determines (e.g., with a processing device of a server computer) a total quantity of distributable tokens by dividing the calculated net present value by a standardized unit value, with the unit value derived from market comparable transactions for similar deposits.

In step 1016, the tokenization method 1000 receives, via the GUI into the server computer, validation of the value calculations from a qualified person as defined under NI 43-101 or S-K 1300. In step 1018, the tokenization method 1000 issues (e.g., with a processing device of a server computer) distributed ledger tokens representing fractional interests in the validated deposit value, with each token incorporating a smart contract that: includes references to the underlying resource calculations and technical assumptions, establishes mechanisms for value updates based on new technical data or market conditions, and defines token holder rights regarding value realization.

In step 1020, the tokenization method 1000 records the token issuance and underlying valuations in a distributed ledger maintained across validating nodes. In step 1022, the tokenization method 1000 credits the initial quantity of value-backed tokens to the titleholder's electronic wallet.

According to embodiments, FIG. 10 illustrates a tokenization method 1000 relating to the tokenization of a single gold deposit using a digital cutoff grade methodology. According to embodiments, the tokenization method 1000 may be executed to tokenize any number of gold deposits. According to embodiments, the tokenization method 1000 may be executed to establish a fungible token that represents a fractional value related to a plurality of total unmined gold deposits across a plurality of locations.

According to embodiments, the asset management system 100 performs the tokenization method 1000 using the digital cutoff grade as an input for the valuation framework applied to each tokenized deposit. In an embodiment, the asset management system 100 analyzes each specific deposit's geological confidence factors and generates a deposit risk profile that quantifies the credibility and reliability of the resource for digital currency backing. In an embodiment, deposits with higher geological confidence (e.g., measured resources with a factor of 0.8) receive more favorable token valuations, while those with lower confidence levels (e.g., inferred resources with a factor of 0.2) reflect the increased uncertainty in their token allocations. According to embodiments, the digital cutoff grade may be modified by applying additional risk factors including accessibility considerations, geopolitical stability analysis, and Environmental, Social, and Governance (ESG) criteria to create a composite credibility factor for a hybrid risk-adjusted digital cutoff grade.

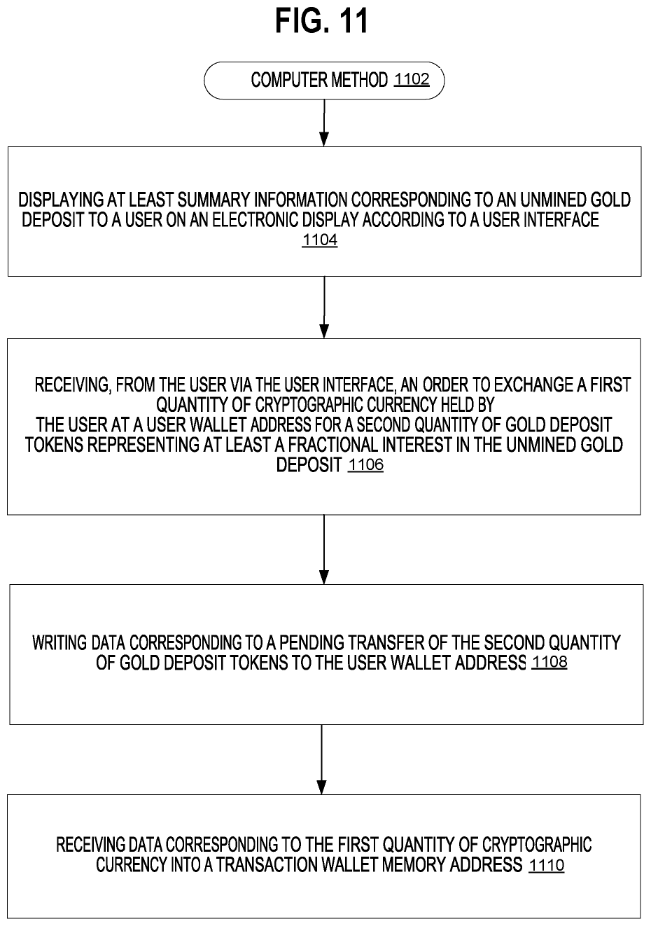

FIG. 11 is a flow chart showing a method 1102 executable by an asset management system (e.g., asset management system 100 of FIG. 1) for secure transfer of a blockchain token representing an interest in an unmined gold deposit, according to embodiments of the present disclosure.

In step 1104, a processing device (e.g., a processing device of the asset management system 100 of FIG. 1) displays at least summary information corresponding to an unmined gold deposit to a user on an electronic display according to a user interface. According to embodiments, the summary information corresponding to the unmined gold deposit, as used here and as referenced throughout this disclosure, may include one or more of an identifier, a description, a country where the deposit is located, current and/or prior owner information, identification of geological surveys conducted, one or more resource estimates compliant with one or more standards (e.g., NI 43-101 or S-K 1300 standards), one or more dates related to claim validity and/or expiration, geological surveys related to the gold deposit, and/or an identifier of related gold deposits. According to embodiments, the summary information includes tokenization information such as current token holder(s), types and/or terms of ownership, and/or availability of tokens. According to embodiments, the summary information may identify a type of the gold deposit, e.g., placer, lode, proven reserves, probable reserves, or the like, a pending resource verification, and/or geological assessment. According to embodiments, the summary information may identify a chain of title in the gold deposit.

According to embodiments, in step 1104, the asset management system 100 may distinguish the summary information associated with the traditional cutoff grade resource estimates and the DCG-adjusted resource estimates to ensure transparency.

According to embodiments, step 1104 facilitates a process for amending technical reports using the digital cutoff grade methodology through the following steps. According to embodiments, the asset management system (e.g., asset management system 100 of FIG. 1) ingests the original NI 43-101 or S-K 1300 technical report through data extraction algorithms that identify key elements including resource classification tables, economic assumptions, geological descriptions, and risk factors.

According to embodiments, the asset management system applies the digital cutoff grade conversion methodology to transform traditional cutoff grade values into digital cutoff grades. According to embodiments, this involves calculating the pure digital cutoff grade using the formula DCG_pure=G\_target/F_geo, where G_target is the desired effective gold content and F_geo represents the geological confidence factors (e.g., a geological confidence factor of 0.8 for measured resources, a geological confidence factor of 0.4 for indicated resources, and a geological confidence factor of 0.2 for inferred resources).

According to embodiments, the asset management system 100 may apply additional factors using the hybrid risk-adjusted digital cutoff grade formula by incorporating accessibility factors, geopolitical stability factors, and ESG factors to calculate a composite risk profile. According to embodiments, the asset management system then generates revised resource tables showing both traditional and digital cutoff grade-adjusted resource estimates to maintain transparency.

According to embodiments, the amended technical report further comprises new sections specifically addressing tokenization considerations, such as token valuation methodologies, update mechanisms, and risk disclosure specific to digital asset backing. According to embodiments, these sections are essential for compliance with securities regulations applicable to digital tokens backed by physical assets.

According to embodiments, once the technical report amendment is complete, the asset management system 100 may generate a validation request for the qualified person who authored the original report. According to embodiments, after review and digital signature authorization, the digital cutoff grade-adjusted amended technical report becomes the official documentation for tokenization purposes and is stored in a secure, immutable format within the distributed ledger system.

According to embodiments, in step 1106, the processing device receives, from the user via the user interface, an order to exchange a first quantity of cryptographic currency held by the user at a user wallet address for a second quantity of gold deposit tokens representing at least a fractional interest in the unmined gold deposit. According to embodiments, the term “user wallet address” may include a data string, such as an alphanumeric code, that is generated to receive transactions and transmit transactions. In an embodiment, the user wallet address may be generated from a public key. The public key is derivable from a private key known to a party having ownership of the wallet (or alternatively, from a private key that is held in custody of the wallet), but the private key cannot be derived from the public key, owing to use of a hyperbolic function that is a “one-way” function. The contents (and authority for transferring the contents) of a wallet address are accessible by the party holding the private key.

According to embodiments, at step 1108, the processing device writes data corresponding to a pending transfer of the second quantity of gold deposit tokens to the user wallet address. According to embodiments, in step 1110, the processing device receives data corresponding to the first quantity of cryptographic currency into a transaction wallet memory address.

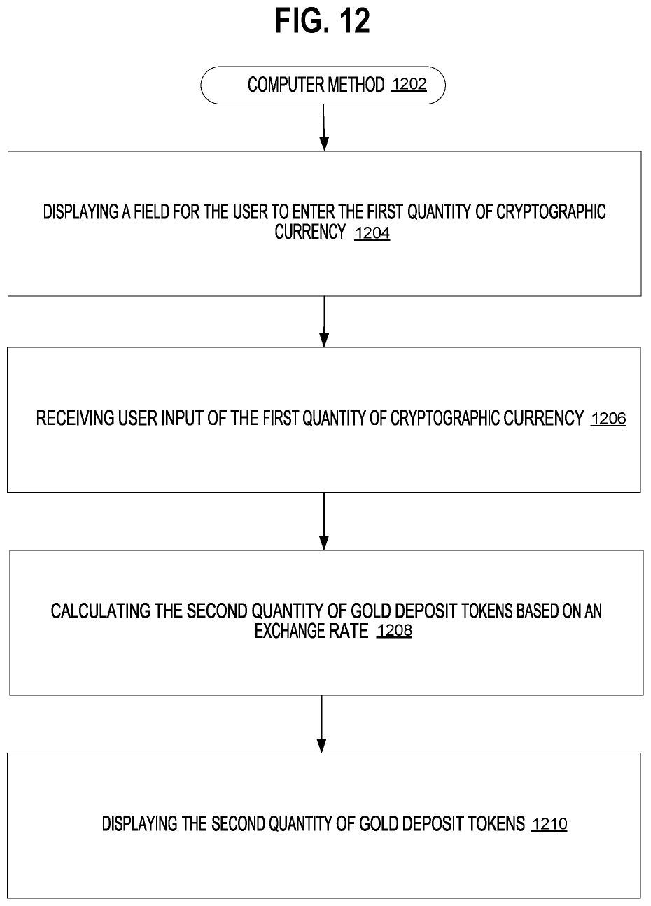

FIG. 12 is a flow chart illustrating a method 1202 executable by an asset management system (e.g., asset management system 100 of FIG. 1) for displaying a quantity of blockchain tokens representing an unmined gold deposit corresponding to a selected amount of a cryptographic currency as a function of an exchange rate, according to one or more embodiments.

In step 1204, a processing device (e.g., a processing device of the asset management system 100 of FIG. 1) displays a field for the user to enter the first quantity of cryptographic currency. In step 1206, the processing device receives user input of the first quantity of cryptographic currency. In step 1208, the processing device calculates the second quantity of gold deposit tokens based on an exchange rate. In an embodiment, in step 1208, the processing device further calculates the exchange rate based on relative supply and demand of the cryptographic currency and the gold deposit tokens. In an embodiment, the processing device calculates the exchange rate based on a supply and demand of the cryptographic currency and a specified price of the gold deposit tokens. In step 1210, the processing device displays the second quantity of gold deposit tokens.

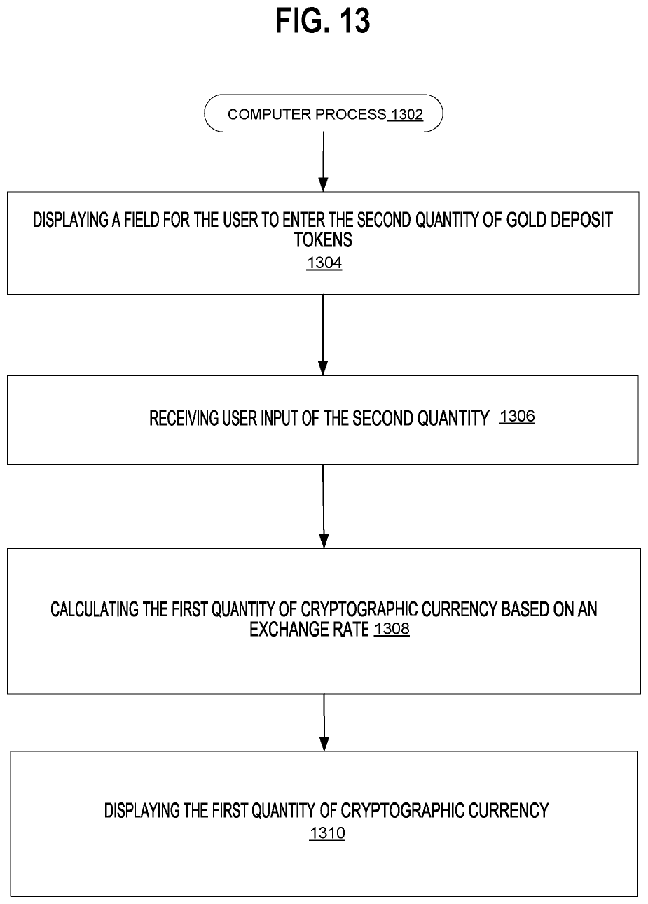

FIG. 13 is a flow chart illustrating a method 1302 executable by an asset management system (e.g., asset management system 100 of FIG. 1) for displaying a quantity of a cryptographic currency corresponding to a selected amount of blockchain tokens representing an unmined gold deposit as a function of an exchange rate, according to one or more embodiments. According to embodiments, the method 1302 may be performed as part of the displaying of at least summary information about the unmined gold deposit from step 1104 of FIG. 11.

In step 1304, a processing device (e.g., a processing device of the asset management system 100 of FIG. 1) displays a field for the user to enter the second quantity of gold deposit tokens. In step 1306, the processing device receives user input of the second quantity. In step 1308, the processing device calculates the first quantity of cryptographic currency based on an exchange rate. In step 1310, the processing device displays the first quantity of cryptographic currency.

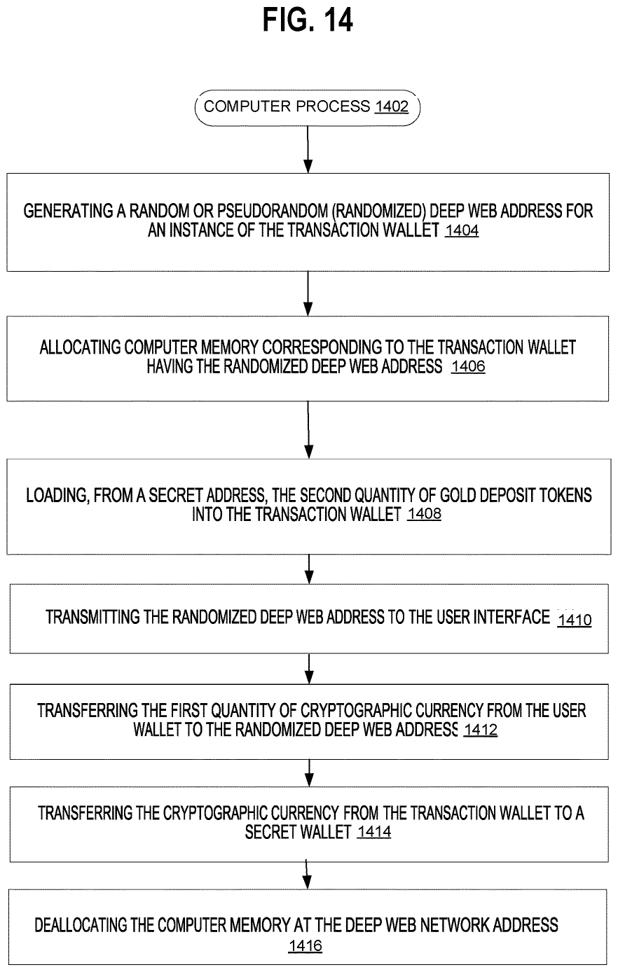

FIG. 14 is a flow chart illustrating a method 1402 executable by an asset management system (e.g., asset management system 100 of FIG. 1) for exchanging a cryptographic currency for blockchain tokens representing an unmined gold deposit, according to one or more embodiments. According to embodiments, method 1402 may be performed as part of the display of at least summary information about the unmined gold deposit from step 1104 of FIG. 11, where step 1104 includes displaying a field for the user to enter a committed bid price of the gold deposit tokens. According to embodiment, method 1402 may be performed as part of the receiving of the order to exchange the first quantity of cryptographic currency for the second quantity of gold deposit tokens from step 1106 of FIG. 11, wherein step 1106 further includes receiving the committed bid price. In an embodiment, the smart contract may include the commitment to sell at least a portion of the gold deposit tokens at the committed bid price. In an embodiment, additionally, or alternatively, displaying at least summary information about an unmined gold deposit from step 1104 of FIG. 11 may include displaying a committed selling price. In an embodiment, the smart contract includes the commitment to sell at least a portion of the gold deposit tokens at the committed selling price.

With reference to FIG. 14, in step 1404, the processing device may generate a random or pseudorandom (e.g., randomized) deep web address for an instance of a transaction wallet. For example, step 1404 may include generating a new public key not previously associated with a blockchain transaction or generating a new private key and deriving a new public key from the new private key not previously associated with a blockchain transaction.

In step 1406, the processing device allocates computer memory corresponding to the transaction wallet having the randomized deep web address (e.g., a deep web network address). In step 1408, the processing device loads (e.g., retrieves, receives, collects, etc.), from a secret address, the second quantity of gold deposit tokens into the transaction wallet. In step 1410, the processing device transmits the randomized deep web address (e.g., the deep web network address) to the user interface. In an embodiment, a deep web network address includes a first portion that is indexed by and/or linked from a surface web location accessible by conventional web search engines, and a second portion that is unpredictable and sufficiently long to substantially prevent systematic search. In an embodiment, the deep web network address may thus be non-indexed and non-linked. In an embodiment, the deep web network address may be uncrawlable. According to a solution variant, the deep web network address does not require registration or login. In an alternative solution variant, the deep web network address may be a contextual address, such as an address configured to be accessible to query by devices having a predetermined URL access history. The deep web network address may be generated by a JavaScript or other randomizing or pseudo-randomizing application. According to an embodiment, the deep web network address may include a Uniform Resource Identifier (URI) including a URL that is indexed and, associated with the URL, a non-indexed query including a passcode that is generated by a random number or pseudo-random number generator and which provides a path to the proposal.

In step 1412, the processing device transfers (e.g., causes an electronic transfer) the first quantity of cryptographic currency from the user wallet to the randomized deep web network address. In step 1414, the processing device transfers the cryptographic currency from the transaction wallet to a secret wallet. In step 1416, the processing device deallocates the computer memory at the deep web network address.

According to one or more embodiments, the cryptographic currency includes value carried by a public blockchain. Additionally or alternatively, the cryptographic currency includes at least one transaction history verifiable by the public blockchain. In an embodiment, the cryptographic currency includes fungible value. In an embodiment, the cryptographic currency includes at least one transaction history carried by a permissioned blockchain.

According to embodiments, with reference to FIG. 11, the method 1102 may include the fulfillment of a smart contract to validate the gold deposit tokens. In an embodiment, in step 1106, the at least a fractional interest in the unmined gold deposit may include at least fractional ownership of the unmined gold deposit. Additionally, or alternatively, the at least a fractional interest in the unmined gold deposit may include at least fractional rights to a revenue stream from the unmined gold deposit.

According to embodiments, in step 1104, the unmined gold deposit may include a verified resource estimate. Additionally, or alternatively, the unmined gold deposit may include a standards-compliant resource assessment. In an embodiment, the unmined gold deposit may include a pending resource verification. In an embodiment, the unmined gold deposit may include a geological survey. In an embodiment, the unmined gold deposit may include an assay report. In an embodiment, the unmined gold deposit may include geophysical data. In an embodiment, the unmined gold deposit may include drill core data.

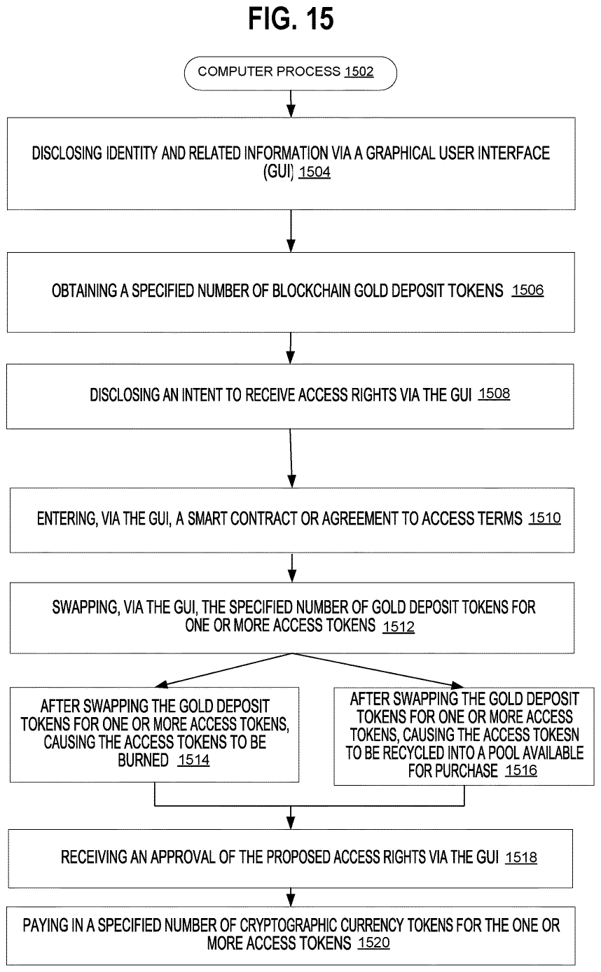

FIG. 15 is a flow chart illustrating a method 1502 for receiving or obtaining access rights to an unmined gold deposit. According to embodiments, in step 1504, a processing device discloses an identity and related information via a graphical user interface (GUI) on an electronic device (e.g., a user device) networked to a server computer. In an embodiment, step 1504 may include establishing a user account with a digital gold exchange, using the GUI.

In step 1506, a specified number of blockchain gold deposit tokens are obtained, where each token represents a fractional interest in an unmined gold deposit, by swapping a cryptographic currency value for the gold deposit tokens via the GUI. In an embodiment, the specified number of gold deposit tokens, obtained in step 1506, is constant. In an embodiment, the specified number of gold deposit tokens, obtained in step 1506, is variable. In an embodiment, the specified number of gold deposit tokens, obtained in step 1506, is a function of a number of the gold deposit tokens, corresponding to a particular unmined gold deposit, in circulation.

In an embodiment, the specified number of gold deposit tokens is a function of the identity of the proposed token holder. For example, a lister of a gold deposit may require a larger number of tokens from a known competitor. In an embodiment, the specified number of gold deposit tokens is a function of projected annual value of the gold deposit. In an embodiment, the specified number of gold deposit tokens is a function of a size of the proposed token holder. In a solution variant, the specified number of gold deposit tokens is a function of a territory of the proposed token holder. In an embodiment, the specified number of gold deposit tokens is a function of environmental preservation commitments. In a solution variant, the specified number of gold deposit tokens is a function of a territory allowed under the access rights.

In an embodiment, the specified number of gold deposit tokens is a function of a territory excluded under the access rights. In an embodiment, the specified number of gold deposit tokens is a function of a duration of the access rights. In an embodiment, the specified number of gold deposit tokens is a function of a limitation to exploratory activities. In a solution variant, the specified number of gold deposit tokens is a function of resource estimates covered under the access rights. In an embodiment, the specified number of gold deposit tokens is a function of other considerations to be paid for the access rights or related agreement.

In step 1508, an intent to receive access rights is disclosed (e.g., communicated) via the GUI. In an embodiment, the computer process 1502 for obtaining access to an unmined gold deposit includes, in step 1508, entering information related to intended activities via the GUI. In response to receipt of the information related to the intended activities, a server computer may assemble a list of relevant unmined gold deposits available for access according to the respective description of each. For example, the list may be assembled using, for example, Machine Learning (e.g., one or more machine learning models), Neural Networks, Bayesian logic, Boolean logic or other computing machine processes based on comparing terminology (including synonyms, noun pairs, bigrams, etc.) and relationships between terms in the intended activities description to terminology and relationships between terms in descriptions of a population of available unmined gold deposits. The approach may be similar to performing a search combined with sorting for relevance.

In step 1510, a smart contract or agreement to access terms is entered via the GUI. In an embodiment, in step 1510, the computer method 1502 includes receiving a listing of unmined gold deposits related to the intended activities and recommended for access.

In step 1512, via the GUI, the specified number of gold deposit tokens is swapped (e.g., exchanged) for one or more access tokens. In an embodiment, the access token may carry a contract granting a right to engage in activity related to the unmined gold deposit while maintaining environmental preservation. In an embodiment, the computer process 1502 includes, in step 1512, determining that further refinement in the intended activities description is desirable to reduce extraneous recommended listings. In an embodiment, the computer method 1502 includes repeating the steps of entering intended activities information, shown in step 1510, and receiving a refined listing of unmined gold deposits recommended for access.

In an embodiment, in step 1514, swapping the gold deposit tokens for one or more access tokens causes the access tokens to be burned. In an embodiment, in step 1516, swapping the gold deposit tokens for one or more access tokens causes the access tokens to be recycled into a pool available for purchase.

In an embodiment, the method 1502 includes, in step 1518, receiving an approval of the proposed access rights via the GUI. In an embodiment, obtaining a specified number of gold deposit tokens representing a fractional interest in an unmined gold deposit, in step 1506, further includes obtaining a specified number of gold deposit tokens representing fractional interests in a plurality of respective unmined gold deposits. In this way, a digital gold exchange may offer bundled gold deposit packages. In an embodiment, each one of a plurality of obtained gold deposit tokens represents an interest in one unmined gold deposit. In another solution variant, one or more of the obtained gold deposit tokens represent an interest in a plurality of unmined gold deposits.

In an embodiment, swapping the specified number of gold deposit tokens for one or more access tokens, in step 1520, further includes paying, in a specified number of cryptographic currency tokens, for the one or more access tokens.

According to embodiments, the gold deposit token may correspond to a verified resource estimate or pending verification. In one or more other embodiments, the gold deposit token may correspond to exploration rights. In one or more other embodiments, the gold deposit token may correspond to a distributorship, a right to resell, and/or to a franchise.

FIG. 16 is a diagram illustrating an example distributed electronic ledger system 1602 communicatively coupled to an asset management system 100, 1600, according to embodiments. In an embodiment, the distributed electronic ledger system 1602 includes a distributed ledger 1616 that is stored and maintained in a decentralized manner across a plurality of participating nodes 1610, in accordance with one or more embodiments of the present disclosure. In an embodiment, the distributed ledger 1616 is implemented as a blockchain architecture, utilizing cryptographic linking between sequential data blocks to ensure data integrity and immutability. In an embodiment, each node 1610 represents a special purpose computing device equipped with specialized software, which maintains operative communication with other nodes 1610 over a secure, redundant network infrastructure.

According to embodiments, the nodes can be categorized into different operational roles, where one or more nodes are owned, managed, or otherwise operated by a managing entity system that possesses elevated privileges to write to, publish to, or otherwise communicate with the other nodes 1610 in the distributed electronic ledger system 1602. According to embodiments, each participating node 1610 hosts either a complete copy of the distributed ledger 1616 for maximum redundancy, or a partial copy based on sharding protocols used scalability.

According to embodiments, when additional data records are proposed for inclusion in the distributed ledger 1616, a multi-phase validation process is initiated. One or more nodes 1610 (e.g., all participating nodes) execute a validation procedure on the proposed additional data records through a consensus algorithm. According to embodiments, the validation process encompasses verification of data structure, cryptographic signatures, transaction validity, and compliance with network rules. After successful validation through the consensus mechanism, the proposed data record undergoes commitment, ensuring it is simultaneously added to each copy of the distributed ledger 1616 across all participating nodes 1610 in a consistent manner.

According to embodiments, the distributed electronic ledger system 1602 may implement various types of consensus algorithms to ensure the integrity and authenticity of data within the distributed ledger. According to embodiments, the relationship between data validation and consensus varies by implementation. In an embodiment, validation of data records is integrated into the consensus algorithm itself. In an embodiment, validation operates as an independent computing layer that complements the consensus mechanism.

According to embodiments, the consensus mechanism implements a “proof of work” (“POW”) algorithm, where nodes perform computationally intensive calculations to solve complex cryptographic puzzles. For validation of pending data records, nodes must calculate a cryptographic hash using algorithms (e.g., SHA256) that satisfies specific dynamic difficulty conditions established by the system. This process, termed “mining,” transforms certain participating nodes into “miners” or “miner nodes.” According to embodiments, the distributed electronic ledger system 1602 implements adaptive difficulty targeting by requiring the resulting hash value to fall below a dynamically adjusted threshold. In these solution variants, nodes combine multiple elements into their calculations: a “base string” (e.g., including metadata within a block header, comprising Merkle root hashes, previous block hashes, timestamps, and version information) with a “nonce” (i.e., an incrementing numerical value). During hash calculation using the POW algorithm, the nonce is initialized to 0 and systematically incremented by 1 until a node discovers a nonce value producing a hash that satisfies the current difficulty target. Upon finding a valid solution, the successful node immediately broadcasts both the solution and its proof to all other network nodes for independent verification. Following thorough validation of the “winning” solution by other nodes through parallel verification, the pending data record is cryptographically appended to the terminal block in the distributed ledger.

According to embodiments, the distributed electronic ledger system 1602 also comprises fork resolution mechanisms for cases where multiple nodes generate valid solutions within a short time window. In an embodiment, nodes implementing the POW algorithm converge on the chain demonstrating the highest cumulative proof of work (i.e., the chain requiring the greatest computational effort) as the canonical version of the distributed ledger. Any nodes maintaining divergent ledger versions execute a reconciliation protocol to synchronize with the consensus-determined canonical chain.

According to embodiments, the distributed electronic ledger system 1602 employs a “proof of stake” (“PoS”) algorithm, where validation authority is proportionally distributed based on participants' “stake” within the distributed ledger. The stake quantification system is multifaceted, incorporating factors such as cryptocurrency holdings, token ownership, asset shares, reputation points, or a weighted combination thereof within the distributed ledger ecosystem as it applies to the unmined gold tokens. Block creation and validation rights are allocated through a voting mechanism where voting power correlates directly with stake size. The next canonical block is determined through a weighted consensus process that considers both the number of votes and the stake-weight behind each vote. Participants with larger stakes receive proportionally greater voting allocation rights, creating an economic incentive for maintaining ledger integrity while simultaneously protecting against manipulation attempts.

According to embodiments, the distributed electronic ledger system 1602 includes a “practical byzantine fault tolerance” (“PBFT”) algorithm, where each node maintains and utilizes an internal state machine for validation purposes. In an embodiment, the process begins when a user or node submits a formally structured request to post a pending data record to the distributed ledger. Each participating node executes the PBFT algorithm against both the pending data record and its current internal state representation, performing rigorous validity checks and state transition calculations. Upon completion of local validation, nodes broadcast cryptographically signed votes (affirming or rejecting validity) to all other network participants. In an embodiment, the distributed electronic ledger system 1602 achieves consensus through a tallying mechanism that considers both the total number of votes and the network's fault tolerance threshold. Once a qualified supermajority of nodes (typically 2f+1 in a system tolerating f failures) have voted in favor, the pending data record is officially designated as “valid” and is atomically committed to the distributed ledger across all participating nodes.

According to embodiments, the distributed ledger 1616 implements append-only semantics, prohibiting direct modification of existing data records or associated metadata within the distributed ledger structure (e.g., blocks in a blockchain). Alternative solution variants support controlled modification capabilities while maintaining audit trails through an advanced versioning system that preserves the complete history of data record versions and all modifications. This ensures the distributed ledger 1616 maintains a complete, immutable history of all transactions since genesis. The system incorporates fault tolerance mechanisms if any Node 1610 becomes unavailable (due to network partitions, hardware failures, security compromises, or other disruptions), the remaining nodes 1610 continue to maintain consensus and serve verified copies of the distributed ledger 1616. Furthermore, the system implements data integrity protection-if data records within a particular node 1610's copy of the distributed ledger 1616 are compromised through deletion, unauthorized modification, or other means, the remaining nodes 1610 serve as authoritative references for ledger reconstruction. The distributed electronic ledger system 1602 supports multiple recovery modes: in some embodiments, compromised nodes 1610 are quarantined to prevent propagation of corrupted data. In other embodiments, compromised nodes 1610 execute self-healing protocols to reconstruct their local ledger copy using verified data from healthy nodes 1610, coordinated through the consensus mechanism.

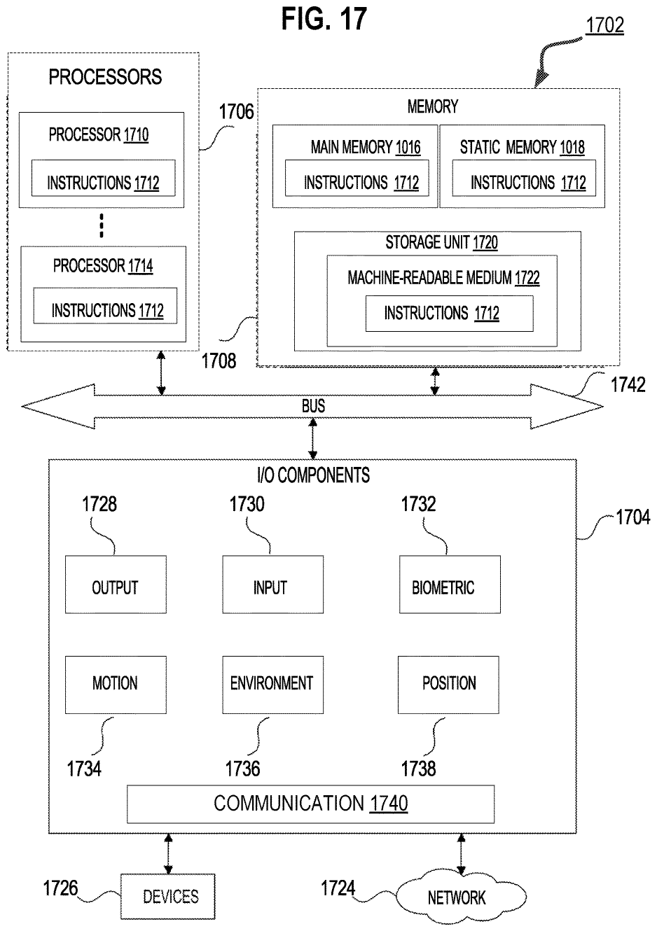

FIG. 17 is a diagrammatic representation of a variant of a machine 1702 implementing embodiments of the present disclosure (described herein with reference to the asset management system 100 within which instructions 1712 (e.g., software, a program, an application, an applet, an app, or other executable code) for causing the machine 1702 and its processors 1706 or processor 1714 to perform any one or more of the methodologies discussed herein may be executed. For example, the instructions 1712 may cause the machine 1702 to execute any one or more of the methods described herein. The instructions 1712 transform the general, non-programmed machine 1702 into a particular machine 1702 programmed to carry out the described and illustrated functions in the manner described. The machine 1702 may operate as a standalone device or may be coupled (e.g., networked) to other machines in a local and/or cloud instance.. In a networked deployment, the machine 1702 may operate in the capacity of a server machine or a client machine in a server-client network environment, or as a peer machine in a peer-to-peer (or distributed) network environment. The machine 1702 may comprise, but not be limited to, a server computer, a client computer, a personal computer (PC), a tablet computer, a laptop computer, a netbook, a PDA, a cellular telephone, a smart phone, a mobile device, a wearable device, other smart devices, a web appliance, a network router, a network switch, a network bridge, or any machine capable of executing the instructions 1712, sequentially or otherwise, that specify actions to be taken by the machine 1702. Further, while only a single machine 1702 is illustrated, the term “machine” shall also be taken to include a collection of machines that individually or jointly execute the instructions 1712 to perform any one or more of the methodologies of this solution as discussed herein.

The machine 1702 may include processors 1706, memory 1708, and I/O components 1704, which may be configured to communicate with each other via a bus 1742. In an example of the solution, the processors 1706 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an ASIC, a Radio-Frequency Integrated Circuit (RFIC), another Processor, or any suitable combination thereof) may include, for example, a processor 1710 and a processor 1714 that execute the instructions 1712. In an embodiment, the term “processor” is intended to include multi-core processors that may comprise two or more independent processors (sometimes referred to as “cores”) that may execute instructions contemporaneously. Although FIG. 17 shows multiple processors 1706, the machine 1702 may include a single processor with a single core, a single processor with multiple cores (e.g., a multi-core processor), multiple processors with a single core, multiple processors with multiples cores, or any combination thereof.

The memory 1708 includes a main memory 1716, a static memory 1718, and a storage unit 1720, both accessible to the processors 1706 via the bus 1742. The main memory 1716, the static memory 1718, and storage unit 1720 store the instructions 1712 embodying any one or more of the methodologies or functions described herein. The instructions 1712 may also reside, completely or partially, within the main memory 1716, within the static memory 1718, within machine-readable medium 1722 within the storage unit 1720 within at least one of the processors 1706 (e.g., within the processor's cache memory), or any suitable combination thereof, during execution thereof by the machine 1702.

The I/O components 1704 may include a wide variety of components to receive input, provide output, produce output, transmit information, exchange information, capture measurements, and so on. The specific I/O components 1704 that are included in a particular machine will depend on the type of machine. For example, portable machines such as mobile phones may include a touch input device or other such input mechanisms, while a headless server machine will likely not include such a touch input device. It will be appreciated that the I/O components 1704 may include many other components that are not shown in FIG. 17. In various example of the solutions, the I/O components 1704 may include output components 1728 and input components 1730. The output components 1728 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1730 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example of the solutions, the I/O components 1704 may include biometric components 1732, motion components 1734, environmental components 1736, or position components 1738, among a wide array of other components. For example, the biometric components 1732 of this solution include components to uniquely key to a particular user to a particular token as identified by the solution and the like.

Communication may be implemented using a wide variety of technologies. The I/O components 1704 further include communication components 1740 operable to couple the machine 1702 to a network 1724 or devices 1726 via respective coupling or connections. For example, the communication components 1740 may include a network interface component or another suitable device to interface with the network 1724. In further examples, the communication components 1740 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1726 may be another machine or any of a wide variety of peripheral devices (e.g., a peripheral device coupled via a USB).

Moreover, the communication components 1740 may detect identifiers or include components operable to detect identifiers. For example, the communication components 1740 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1740, such as location via Internet Protocol (IP) geolocation, location via Wi-Fi® signal triangulation, location via detecting an NFC beacon signal that may indicate a particular location, and so forth.

The various memories (e.g., main memory 1716, static memory 1718, and/or memory of the processors 1706) and/or storage unit 1720 may store one or more sets of instructions and data structures (e.g., software) embodying or used by any one or more of the methodologies or functions described herein. These instructions (e.g., the instructions 1712), when executed by processors 1706 cause various operations to implement the disclosed examples of the solutions.

The 1712 may be transmitted or received over the network 1724, using a transmission medium, via a network interface device (e.g., a network interface component included in the communication position components 1738) and using any one of several well-known transfer protocols (e.g., hypertext transfer protocol (HTTP)). Similarly, the instructions 1710 may be transmitted or received using a transmission medium via a coupling (e.g., a peer-to-peer coupling) to the devices 1726 or alternatively one or more Nodes 1610 in a Distributed Ledger 1616 system.

The detailed description serves as an illustrative example, and it is not exhaustive of all potential implementation variants. Due to the impracticality of describing every conceivable blockchain solution—whether using current consensus mechanisms or those developed after this patent's filing—alternate configurations may exist that still fall within the scope of the claims.

Throughout this specification, references to singular instances of nodes, blocks, or transactions includes plural instances, and vice versa. Likewise, while blockchain operations are described separately, they can be performed concurrently or in a different sequence than presented. Components or functionalities described as separate in example configurations (such as mining and validation) may be combined, while those presented as a single entity may be divided into multiple components. These and other modifications or improvements to the blockchain architecture remain within the bounds of the described embodiments.

In certain implementation variants, blockchain logic, smart contracts, consensus algorithms, or cryptographic operations may be executed via software (e.g., code on a non-transitory, machine-readable medium) or hardware (e.g., specialized mining processors). In a hardware context, these operations can be physical, tangible units configured in specific ways, such as through application-specific integrated circuits (ASICs) or mining-specific processors. Alternatively, they may leverage general-purpose processors configured temporarily via software to execute specific blockchain operations. Decisions on whether to implement consensus mechanisms in dedicated hardware, software, or hybrid solutions may depend on energy efficiency, hash rate requirements, or other constraints.

For purposes of clarity, “blockchain node” should be understood to mean a tangible entity that can either be physically constructed or configured (permanently or temporarily) to operate in a specific manner within the network. If temporarily configured via software, a general-purpose processor may act as various types of nodes at different times. This flexibility enables the same processor to perform multiple functions dynamically, depending on the network's current needs.

Inter-node communication between blockchain participants may occur through peer-to-peer networks or other distributed systems. When nodes process blocks at different times, data can be stored and retrieved from distributed ledgers, enabling asynchronous operation. For instance, a mining node may execute a proof-of-work operation and broadcast its results to the network, allowing other nodes to validate and process the information later.

The operations of blockchain methods described in various implementation variants may be partially or fully implemented by one or more nodes. These nodes may be physically located within a single network or distributed across multiple systems, enabling decentralized processing. In some cases, these systems may be in a centralized pool, like a mining farm, while in other cases, they could be spread across multiple geographic locations. When nodes are distributed, they may communicate and coordinate their tasks via blockchain protocols, forming a cohesive network.

Terminology used herein, such as “mining,” “validation,” or “consensus,” refers to the manipulation of data in cryptographic forms, such as hashes, digital signatures, or Merkle trees. When the specification refers to “an embodiment”, “one or more embodiments”, “one implementation variant” or “an implementation variant,” it indicates that the described feature may be applicable to at least one possible blockchain solution. This should not imply that all instances of the phrase refer to the same implementation variant.

Additionally, terms like “comprises,” “including,” and their variants are intended to imply non-exclusive inclusion. For instance, a blockchain method that “comprises” certain elements is not limited to those elements alone and includes other components not explicitly listed. Similarly, “or” should be interpreted as inclusive unless otherwise specified, meaning proof-of-work or proof-of-stake could be implemented individually or in hybrid forms.

The descriptions provided are intended as illustrative, non-exhaustive examples of blockchain implementations. They do not define every possible implementation variant, as doing so would be impractical, if not impossible. Moreover, technological advancements in cryptography, consensus mechanisms, and alternate configurations may arise that still fall within the scope of the present disclosure.

What is claimed is:

1. A method comprising:
receiving, by a processing device via a graphical user interface, proof of title documentation for an unmined gold deposit;
receiving, via the graphical user interface, resource verification documentation compliant with at least one regulatory standard corresponding to the unmined gold deposit;
generating a digital cutoff grade for the unmined gold deposit based on a geological confidence factor assigned to a resource classification of the unmined gold deposit;
calculating a net present value associated with the unmined gold deposit based at least in part on the digital cutoff grade;
determining, based on the net present value, a total quantity of distributable tokens;
issuing, based on the total quantity of distributable tokens, a set of distributed ledger tokens representing fractional interests of the net present value;
recording the issuing of the set of distributed ledger tokens in a distributed ledger maintained across a plurality of validating nodes; and
transferring the set of distributed ledger tokens to an electronic wallet associated with a titleholder.

2. The method of claim 1, wherein generating the digital cutoff grade comprises:
establishing a target gold content representing a desired effective gold content to provide backing for digital tokens; and
dividing the target gold content by the geological confidence factor to determine the digital cutoff grade for the resource classification.

3. The method of claim 2, wherein generating the digital cutoff grade further comprises:
calculating a pure digital cutoff grade by dividing a target gold content by the geological confidence factor assigned to the resource classification.

4. The method of claim 1, wherein generating the digital cutoff grade further comprises:
calculating a hybrid risk-adjusted digital cutoff grade by dividing a target gold content by a composite credibility factor, wherein the composite credibility factor is determined by combining two or more of a geological confidence factor, an accessibility factor, a geopolitical stability factor, or an environmental and environmental, social, and governance (ESG) factor.

5. The method of claim 4, wherein calculating the hybrid risk-adjusted digital cutoff grade further comprises:
assessing accessibility considerations through one or more of depth complexity analysis, infrastructure proximity modeling, or technology feasibility assessment to generate the accessibility factor;
evaluating geopolitical stability using one or more of political risk indexes, regulatory framework databases, historical expropriation records, or jurisdiction ranking systems to generate the geopolitical stability factor; and
analyzing environmental and ESG considerations using one or more of environmental restriction databases, social opposition incident records, indigenous rights frameworks, or governance compliance assessments to generate the environmental and ESG factor.

6. The method of claim 4, wherein the composite credibility factor is determined by multiplying the geological confidence factor by the accessibility factor, the geopolitical stability factor, and the environmental and ESG factor.

7. The method of claim 1, further comprising:
adapting, by the processing device, a technical report compliant with at least one of NI 43-101 or S-K 1300 standards by applying the digital cutoff grade, wherein adapting the technical report comprises:
extracting, using one or more data extraction algorithms executed by the processing device, resource classification tables, economic assumptions, and risk factors from the technical report;
nullifying economic extraction considerations by resetting a traditional cutoff grade;
generating, by the processing device, revised resource tables showing both traditional and digital cutoff grade-adjusted resource estimates;
adding sections addressing tokenization considerations comprising one or more of token valuation methodologies or update mechanisms;
storing the adapted technical report in a secure, immutable format within the distributed ledger; and
generating a validation request for transmission to a qualified person, wherein the adapted technical report is recorded in the distributed ledger upon receipt of a digital signature authorization from the qualified person.

8. The method of claim 1, wherein issuing the set of distributed ledger tokens comprises:
deploying, by the processing device, a series of smart contracts on a blockchain platform, wherein the smart contracts encode the digital cutoff grade as executable validation logic that automatically enforces a minimum ore grade threshold before permitting token issuance;
encoding, within the smart contracts, references to authenticated resource verification documentation and on-chain resource estimates; and
implementing, within the smart contracts, automated compliance checks that validate the resource verification documentation against the at least one regulatory standard before permitting token operations.

9. The method of claim 1, further comprising:
integrating, by the processing device, one or more environmental, social, and governance (ESG) crediting systems with a smart contract infrastructure, wherein integrating the ESG crediting systems comprises:
receiving, via one or more automated oracle-based data feeds, real-time ESG metrics corresponding to the unmined gold deposit;
encoding, within one or more smart contracts, threshold parameters for the ESG metrics;
automatically adjusting an environmental and ESG factor derived from the digital cutoff grade based on the real-time ESG metrics; and
triggering an automated recalculation of a token valuation associated with the unmined gold deposit when the ESG metrics cross a predefined threshold.

10. The method of claim 1, further comprising:
executing, by the processing device, a token burning protocol to reduce a quantity of the distributed ledger tokens associated with the unmined gold deposit when the unmined gold deposit transitions to active mining, wherein executing the token burning protocol comprises:
collecting mining data and generating a cryptographic hash of the mining data for on-chain recording;
receiving validation of extraction data from a qualified person;
receiving verification of compliance from an independent auditor; and
requiring multi-signature validation from a plurality of independent stakeholders comprising operational, technical, and compliance stakeholders before executing a token burn, wherein a burn amount is calculated based on verified extraction data.

11. A non-transitory computer-readable storage medium including instructions that when executed by a processing device, cause the processing device to perform operations comprising:
receiving resource data corresponding to an unmined gold deposit, wherein the resource data includes a resource classification indicating a geological confidence level of the unmined gold deposit;
assigning a geological confidence factor to the unmined gold deposit based on the resource classification;
establishing a target gold content representing a desired effective gold content necessary to provide backing for digital tokens;
generating a digital cutoff grade for the unmined gold deposit by dividing the target gold content by the geological confidence factor; and
outputting the digital cutoff grade for use in a tokenization process associated with the unmined gold deposit.

12. The non-transitory computer-readable storage medium of claim 11, wherein generating the digital cutoff grade comprises calculating a pure digital cutoff grade based at least in part on a geological confidence factor.

13. The non-transitory computer-readable storage medium of claim 11, wherein generating the digital cutoff grade comprises calculating a hybrid risk-adjusted digital cutoff grade by dividing the target gold content by a composite credibility factor, wherein the composite credibility factor is determined by combining the geological confidence factor with one or more of an accessibility factor, a geopolitical stability factor, or an environmental factor.

14. The non-transitory computer-readable storage medium of claim 11, wherein the operations further comprise converting a traditional cutoff grade to the digital cutoff grade by nullifying economic extraction considerations associated with the traditional cutoff grade.

15. The non-transitory computer-readable storage medium of claim 11, wherein the operations further comprise:
ingesting resource data from a plurality of national reporting formats; and
normalizing the resource data into a standardized format for digital cutoff grade calculation using data extraction algorithms calibrated for the plurality of national reporting formats.

16. A system comprising:
a memory to store instructions; and
a processing device operatively coupled to the memory, the processing device to execute the instructions to perform operations comprising:
receiving, via a graphical user interface, proof of title documentation and resource verification documentation compliant with at least one regulatory standard for an unmined gold deposit;
calculating a digital cutoff grade for the unmined gold deposit based on a geological confidence factor assigned to a resource classification of the unmined gold deposit;
calculating a net present value for the unmined gold deposit based at least in part on the digital cutoff grade;
determining a total quantity of distributable tokens based on the net present value;
deploying a smart contract on a blockchain platform, wherein the smart contract encodes the digital cutoff grade to determine a risk-adjusted valuation of the unmined gold deposit and encodes a relationship between the unmined gold deposit and a set of distributed ledger tokens;
issuing the set of distributed ledger tokens representing fractional interests in the net present value, wherein each distributed ledger token incorporates the smart contract;
recording the issuing of the set of distributed ledger tokens in a distributed ledger maintained across a plurality of validating nodes; and
transferring the set of distributed ledger tokens to an electronic wallet associated with a titleholder.

17. The system of claim 16, wherein the smart contract references authenticated NI 43-101 or S-K 1300 technical reports and stores claim coordinates and resource estimates on-chain, and wherein the smart contract is updatable only by authorized qualified persons through protocols that confirm authenticity of the qualified persons.

18. The system of claim 16, wherein the operations further comprise:
integrating one or more ESG crediting systems with the smart contract to track environmental, social, and governance metrics against permitted thresholds, wherein the ESG crediting systems incorporate an environmental and ESG factor derived from the digital cutoff grade to quantify environmental, social, and governance risks associated with the unmined gold deposit.

19. The system of claim 16, wherein the operations further comprise:
implementing a tokenized warehouse receipt framework representing a standardized digital format of a traditional warehouse receipt adapted for the unmined gold deposit, wherein the tokenized warehouse receipt operates under an established legal framework governing documents of title and establishes a chain of title and ownership rights while integrating with existing commodity trading frameworks.

20. The system of claim 16, wherein the operations further comprise:
executing a token burning protocol to reduce a quantity of the distributed ledger tokens when the unmined gold deposit transitions to active mining.
